(19) United States
(12) Patent Application Publication
(10) Pub. No.: US 2020/0362191 A1
(43) Pub. Date: Nov. 19, 2020

(54) HIGH PERFORMANCE AQUEOUS COATING COMPOSITIONS

(71) Applicant: SWIMC LLC, Cleveland, OH (US)

(72) Inventors: Robert Sandoval, Crystal Lake, IL (US); Joseph Klen, Hampshire, IL (US); Mary Jane Hibben, Elburn, IL (US); Michael Wildman, Hoffman Estates, IL (US)

(21) Appl. No.: 16/907,735

(22) Filed: Jun. 22, 2020

Related U.S. Application Data
(63) Continuation of application No. PCT/US2018/066829, filed on Dec. 20, 2018.
(60) Provisional application No. 62/609,919, filed on Dec. 22, 2017.

(51) Int. Cl. C09D 151/00

(52) U.S. Cl. CPC C09D 151/003

(57) ABSTRACT

Coating compositions for cementitious substrates that include water, a multistage latex polymer and an optional silane coupling agent, wherein at least one of the monomers of the latex being capable of keto-hydrazide crosslinking with a component comprising a diamine, triamine or polyamine, such as a dihyrazide, trihydrazide, polyhydrazide, or mixtures thereof. The latex polymer preferably is made from a silane-functional multistage latex polymer wherein at least one of the monomers is capable of keto-hydrazide crosslinking with a dihydrazide, and in some instances at least one of the monomers has at least one amide group. The compositions may be used to coat a variety of substrates, including wood and cement. Articles having the coating applied thereto are also provided.

### RELATED APPLICATIONS

The present application is a continuation application of International Application No. PCT/US2018/066829, filed Dec. 20, 2018 which claims the benefit of U.S. Provisional Application No. 62/609,919 filed Dec. 22, 2017, both of which are hereby incorporated herein in their entireties by reference.

### TECHNICAL FIELD

This invention relates to coating compositions that include a latex polymer.

### BACKGROUND

Hard, abrasion-resistant coatings are used over a variety of substrates, including cement, wood, and porous substrates. Particularly demanding substrates include horizontal substrates such as sidewalks, floor tiles, cement garage floors and decks. Unfortunately, many of the commercially available coatings in use today for these substrates suffer from problems such as poor adhesion or poor water resistance (e.g., “blushing”).

Cement and fiber cement substrates have an additional issue, in that they typically require hard, abrasion-resistant coatings with excellent adhesion. In the past, this has been addressed by using higher-Tg polymer systems. Unfortunately, volatile organic content (VOC) solvents generally must be used to achieve proper coalescence of higher-Tg polymers. Consequently, there is an unmet need to develop acceptable low VOC aqueous based coatings that are hard, blush resistant, abrasion resistant and offer excellent adhesion to cement and fiber cement substrates.

U.S. Pat. Nos. 7,812,090 and 7,834,084 describe high performance coating compositions which adhere well to cementitious substrates, and have improved stability. However, there still remains the need for coating compositions that provide high abrasion/scrub resistance while not significantly impacting adhesion performance or blush resistance.

### SUMMARY

The present invention provides in one aspect a coating composition including water, a multistage latex polymer, and optionally a silane coupling agent. The multistage latex polymer includes two or more polymer stages where each stage has a different T_{g}. In a preferred embodiment, the multistage latex polymer includes at least one soft stage having a Tg between about −65 and less than about 30° C. and at least one hard stage having a Tg greater than 30 and less than about 230° C. The multistage latex polymer preferably is made from one or more monomers capable of a keto-hydrazide crosslinking. In other aspects, the multistage latex polymer preferably is formed from at least one monomer having an amide group and is capable of a keto-hydrazide crosslinking. In some other aspects, the multistage latex polymer preferably is formed from at least one monomer having an amide group and one unsaturated double bond and is capable of a keto-hydrazide crosslinking. In some aspects, the multistage latex polymer is formed from one or more monomers capable of a keto-hydrazide crosslinking in the presence of at least one dihydrazide.

In some other aspects, the multistage latex polymer is formed from one or more monomers capable of a keto-hydrazide crosslinking in the presence of at least one dihydrazide, at least one trihydrazide, at least one polyhydrazide, or mixtures thereof.

In another aspect, the multistage latex polymer further comprises a silane-functional multistage latex polymer. In a preferred embodiment, the silane-functional multistage latex polymer includes at least one soft stage having a Tg between about −65 and less than about 30° C. and at least one hard stage having a Tg greater than 30 and up to about 230° C.

In another aspect, the invention provides a method for preparing a coated article, which method preferably comprises providing a substrate, preferably a cementitious substrate, coating at least a portion of the substrate with an aqueous coating composition comprising a multistage latex polymer, and allowing the coating composition to harden.

In yet another aspect, the present invention provides coated articles comprising a substrate, preferably a cementitious substrate, having at least a portion of a surface on which is coated a layer formed from an aqueous coating composition comprising a multistage latex polymer that has at least one silane-functional soft stage having a Tg calculated by the Fox equation greater than −65° C. and less than 30° C., at least one hard stage having a Tg calculated by the Fox equation greater than 30° C. and less than 230° C., and the multistage latex polymer is derived from one or more monomers, wherein at least one of the one or monomers capable of a keto-hydrazide crosslinking with carbohydrazide, at least one dihydrazide, or mixtures thereof.

The above summary of the present invention is not intended to describe each disclosed embodiment or every implementation of the present invention. The description that follows exemplifies certain illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying specification. Other features, objects, and advantages of the invention will be apparent from the description and from the claims.

### DETAILED DESCRIPTION

The terms “a,” “an,” “the,” “at least one,” and “one or more” are used interchangeably. Thus, for example, a coating composition that contains “an” additive means that the coating composition includes “one or more” additives.

The terms “board” or “fiberboard” refer to a generally planar component suitable for attachment to a building exterior surface, including lap siding, vertical siding, soffit panels, trim boards, shingle replicas, stone replicas and stucco replicas.

The term “cementitious” refers to a substrate or material that comprises cement and has the properties or characteristics of cement, or that comprises a chemical precipitate, preferably of carbonates, having the characteristics of cement. Examples of cementitious substrates and materials include cement, burnished cement, concrete, polished concrete and cement fiberboard, and examples of places or applications where cementitious substrates may be employed include floors (e.g., garage floors), tiles (e.g., floor tiles), decks, boards and panels (e.g., fiber cement boards), and the like.

The term “comprises” and variations thereof does not have a limiting meaning where such term appears in the description or claims. Thus, a composition comprising an ethylenically unsaturated compound means that the composition includes one or more ethylenically unsaturated compounds.

The term “derived from” when used in reference to a polymer or copolymer and one or more monomers means that the polymer or copolymer is made from or could be made from ingredients include the named one or more monomers.

The term “dispersion,” as used herein, in the context of a dispersible polymer refers to the mixture of a dispersible polymer and a carrier. Unless otherwise indicated, the term “dispersion” is intended to include the term “solution.”

The terms “glass transition temperature” or “Tg,” as used herein, refers to the temperature at which an amorphous, solid material undergoes a reversible transition to a molten, rubber-like state. The Tg may be measured by Differential Scanning Calorimetry (DSC) or calculated using the Fox equation. Application of the Fox equation to estimate the Tg of polymers is well known to one skilled in the art.

The terms “group” and “moiety” are used to differentiate between chemical species that allow for substitution or that may be substituted and those that do not allow substitution or that may not be so substituted. Thus, when the term “group” is used to describe a chemical substituent, the described chemical material includes substituted and unsubstituted groups, where the substituent groups may include O, N, Si, or S atoms, for example, in the chain (e.g., an alkoxy group) as well as carbonyl groups and other substituent groups. The term “organic group” thus refers to a hydrocarbon (e.g., hydrocarbyl) group with optional elements other than carbon and hydrogen in the chain, such as oxygen, nitrogen, silicon or sulfur. Representative organic groups include aliphatic groups, cyclic groups, and combinations of aliphatic and cyclic groups (e.g., alkaryl or aralkyl groups). The term “aliphatic group” refers to a saturated or unsaturated linear or branched organic group. For example, this term is used to encompass alkyl, alkenyl, and alkynyl groups. The term “alkyl group” refers not only to pure open chain saturated hydrocarbon alkyl substituents, such as methyl, ethyl, isopropyl, t-butyl, heptyl, dodecyl, octadecyl, amyl, 2-ethylhexyl, and the like, but also to substituted alkyl groups having substituents known in the art, such as hydroxy, alkoxy, alkylsulfonyl, halo, cyano, nitro, amino, carboxyl, and the like. The term “alkenyl group” refers to an unsaturated linear or branched hydrocarbon group with one or more carbon-carbon double bonds and likewise may have substituents known in the art. Non-limiting examples of alkenyl groups include groups such as vinyl, 1-propenyl, 2-propenyl, 1,3-butadienyl, 1-butenyl, 2-butenyl, 1-pentenyl, 2-pentenyl, 1-hexenyl, 2-hexenyl, heptenyl, octenyl and the like. The term “alkynyl group” refers to an unsaturated linear or branched hydrocarbon group with one or more carbon-carbon triple bonds and likewise may have substituents known in the art. Non-limiting examples of alkynyl groups include ethynyl, 1-propynyl, 2-propynyl, 1-butynyl, 2-butynyl, 3-butynyl, 1-pentynyl, 2-pentynyl, 1-hexynyl, 2-hexynyl, heptynyl, octynyl and the like. The term “cyclic group” refers to a closed ring hydrocarbon group that can be classified as an alicyclic group, aromatic group (aryl group), or heterocyclic group. The term “alicyclic group” refers to a cyclic hydrocarbon group having properties resembling those of aliphatic groups. Non-limiting examples of alicyclic groups include cyclopropyl, cyclobutyl, cyclopentyl, cyclohexyl, cycloheptyl, cyclooctyl and the like. The terms “aromatic group” or “aryl group” refer to a mono- or polycyclic aromatic hydrocarbon group including phenyl or naphthyl groups. The term “heterocyclic group” refers to a closed ring hydrocarbon group in which one or more of the atoms in the ring is an element other than carbon (e.g., nitrogen, oxygen, sulfur, etc.). When the term “moiety” is used to describe a chemical compound or substituent, only the unsubstituted chemical material is intended to be included. Thus, the phrase “hydrocarbyl moiety” refers to unsubstituted organic moieties containing only hydrogen and carbon, and the phrase “alkyl moiety” refers to pure open chain saturated hydrocarbon alkyl substituents such as methyl, ethyl, propyl, t-butyl, and the like.

A “latex” polymer means a dispersion or emulsion of polymer particles formed in the presence of water and one or more secondary dispersing or emulsifying agents (e.g., a surfactant, alkali-soluble polymer or mixtures thereof) whose presence is required to form the dispersion or emulsion. In some embodiments, a reactive dispersing or emulsifying agent may become part of the polymer particles as they are formed.

The phrase “low VOC” when used with respect to a liquid coating composition means that the coating composition contains less than 10 weight % volatile organic compounds, more preferably less than 7 weight % volatile organic compounds, and most preferably less than 4 weight % volatile organic compounds based upon the total liquid coating composition weight.

Unless otherwise indicated, a reference to a “(meth)acrylate” compound (where “meth” is in parentheses or bracketed) is meant to include both acrylate and methacrylate compounds.

The term “multistage,” as used herein with respect to a latex polymer, refers to the latex polymer being made using discrete, sequential charges of two or more monomers or monomer mixtures, or using a continuously-varied charge of two or more monomers, such that when the disclosure states that the multistage latex polymer “includes” one or more monomers, this shall be understood to mean that the multistage latex polymer is made or derived from such monomers. Usually a multistage latex will not exhibit a single Tg inflection point as measured by differential scanning calorimetry (DSC). For example, a DSC curve for a multistage latex made using discrete charges of two or more monomers may exhibit two or more Tg inflection points. Also, a DSC curve for a multistage latex made using a continuously-varied charge of two or more monomers may exhibit no Tg inflection points. By way of further explanation, a DSC curve for a single stage latex made using a single monomer charge or a non-varying charge of two monomers may exhibit only a single Tg inflection point. Occasionally when only one Tg inflection point is observed it may be difficult to determine whether the latex represents a multistage latex. In such cases a lower Tg inflection point may sometimes be detected on closer inspection, or the synthetic scheme used to make the latex may be examined to determine whether or not a multistage latex would be expected to be produced.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The terms “preferred” and “preferably” refer to embodiments which may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Unless otherwise indicated, the term “polymer” includes both homopolymers and copolymers (for example, polymers of two or more different monomers).

The term “scrub resistance,” as used herein, refers to the ability of the surface of a coating film or paint film to resist being worn away or to maintain its original appearance when rubbed with or against an abrasive surface, typically during cleaning. The number of scrub cycles for determining scrub resistance is determined herein by Detailed Performance Standard MPI #60 Test Standard (Standard Test Method—Floor Paint, Latex, Low Gloss) The Master Painters Institute Inc., Jan. 4, 2010) using Leneta SC-2 abrasive scrub media with paint formulations being applied to a black mylar substrate having an average wet coating thickness of 7 mil (17.78 μm) using a Dow bar and allowed to cure for 1 week at ambient temperature to achieve an average dry coating thickness of 2.6 mil (6.60 μm), the cured coating being devoid of any visual cracks as observed by an unaided eye of an ordinary observer, and ASTM Method D2486 referenced in Section 7.5 of MPI #60 applied as relating to Test Method B of ASTM Method D2486. To the extent an average wet coating thickness of 7 mil (17.78 μm) using a Dow bar is allowed to cure for 1 week at ambient temperature and does not achieve an average dry coating thickness of 2.6 mil (6.60 μm) and/or contains visual cracks as observed by an unaided eye of an ordinary observer, a different wet coating thickness and/or application method may be required to achieve an average dry coating thickness of 2.6 mil (6.60 μm) that is devoid of visual cracks as observed by an unaided eye of an ordinary observer, such that the number of scrub cycles for determining scrub resistance can be determined using MPI #60 Test Standard. The terms “topcoat” or “final topcoat” refer to a coating composition which when dried or otherwise hardened provides a decorative or protective outermost finish layer on a substrate, e.g., a fiber cement board attached to a building exterior. By way of further explanation, such final topcoats include paints, stains or sealers capable of withstanding extended outdoor exposure (e.g., exposure equivalent to one year of vertical south-facing Florida sunlight) without visually objectionable deterioration, but do not include primers that would not withstand extended outdoor exposure if left uncoated, viz., without a topcoat.

The term “volatile organic compound” (“VOC”), as defined by the Environmental Protection Agency (EPA) in 40 C.F.R. 51.100(s), refers to any compound of carbon, excluding carbon monoxide, carbon dioxide, carbonic acid, metallic carbides or carbonates, and ammonium carbonate, which participates in 20 atmospheric photochemical reactions. Typically, volatile organic compounds have a vapor pressure equal to or greater than 0.1 mm Hg. As used herein, “volatile organic compound content” (“VOC content”) is as measured by ASTM method D2369-90, refers to the weight of VOC per volume of the coating solids, and is reported, for example, as grams VOC per liter (g/L).

As used herein, the term “wet/dry adhesion” refers to the percent of a dried film coating removed from a substrate surface, typically a piece of carerra black glass. The dried film coating typically has an area immersed in water for a period of time (wet adhesion) prior to performance of a cross hatch adhesion test and an area that was not immersed in water (dry adhesion) prior to performance of the test. ASTM D3359 (Standard Test Methods for Measuring Adhesion by Tape Test) may be used to measure wet/dry adhesion.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a of a series of endpoints includes disclosure of not only that range but also all subranges subsumed using such endpoints and also within that range (e.g., 1 to 5 includes 1 to 4, 2 to 3.80, 1.5 to 5, etc.).

The disclosed compositions may be applied to a variety of substrates, including cement, cement tiles, and fiber cement substrates. The compositions may also be applied to wood and wood substitutes. The compositions are particularly useful for coating cementitious substrates including cement floors and fiber cement articles. A variety of fiber cement substrates may be employed. Fiber cement substrates typically are composites made from cement, water and cellulosic fillers. Exemplary fillers include wood, fiberglass, polymers or mixtures thereof. The substrates can be made using methods such as extrusion, the Hatschek method, or other methods known in the art. See, e.g., U.S. Patent Application Publication No. US 2005/0208285 A1; Australian Patent Application No. 2005100347; International Patent Application No. WO 01/68547 A1; International Patent Application No. WO 98/45222 A1; U.S. Patent Application Publication No. US 2006/0288909 A1; and Australian Patent Application No. 198060655 A1. Fiber cement composites can include unprimed fiber cement substrates and commercially available pre-primed or pre-painted fiber cement substrates which may be topcoated as described below. Non-limiting examples of such substrates include siding products, boards and the like, for uses including fencing, roofing, flooring, decking, wall boards, shower boards, lap siding, vertical siding, soffit panels, trim boards, shaped edge shingle replicas, stucco, and stone or stucco replicas. One or both major surfaces of the substrate may be profiled or embossed to look like a grained or roughsawn wood or other building product, or scalloped or cut to resemble shingles. The uncoated substrate surface typically contains a plurality of pores with micron- or submicron-scale cross-sectional dimensions.

A variety of suitable fiber cement substrates are commercially available. For example, several preferred fiber cement siding products are available from James Hardie Building Products Inc. of Mission Viejo, CA, including those sold as HARDIEHOME™ siding, HARDIPANEL™ vertical siding, HARDIPLANK™ lap siding, HARDIESOFFIT™ panels, HARDITRIM™ planks and HARDISHINGLE™ siding. These products are available with an extended warranty, and are said to resist moisture damage, to require only low maintenance, to not crack, rot or delaminate, to resist damage from extended exposure to humidity, rain, snow, salt air and termites, to be non-combustible, and to offer the warmth of wood and the durability of fiber cement. Other suitable fiber cement siding substrates include AQUAPANEL™ cement board products from Knauf USG Systems GmbH & Co. KG of Iserlohn, Germany, CEMPLANK™, CEMPANEL™ and CEMTRIM™ cement board products from Cemplank of Mission Viejo, CA; WEATHERBOARDS™ cement board products from CertainTeed Corporation of Valley Forge, Pa.; MAXITILE™, MAXISHAKE™ AND MAXISLATE™ cement board products from MaxiTile Inc. of Carson, Calif.; BRESTONE™, CINDERSTONE™, LEDGESTONE™, NEWPORT BRICK™ SIERRA PREMIUM™ and VINTAGE BRICK™ cement board products from Nichiha U.S.A., Inc. of Norcross, Ga., EVERNICE™ cement board products from Zhangjiagang Evernice Building Materials Co., Ltd. of China and E BOARD™ cement board products from Everest Industries Ltd. of India.

The disclosed articles and substrates may be coated on one or more surfaces with one or more layers of the coating composition. For example, in one preferred embodiment the coating composition may include an optional primer layer and one or more topcoat layers. An optional sealer layer underneath the primer layer may also be utilized, if desired. Preferably, the various layers are selected to provide a coating system that has good adhesion to the substrate and between adjacent layers of the system.

Exemplary optional sealer layers include acrylic latex materials. The typical function of a sealer layer is to provide one or more features such as improved adhesion, efflorescence blocking, water resistance or blocking resistance. Non-limiting sealers include unpigmented or low pigment level latex coatings having, for example, between about 5 and 20 weight % solids. Examples of commercially available sealers are OLYMPIC™ FC sealer from PPG Industries and H&C Clarishield Water-Based Look Concrete Sealer from Sherwin-Williams.

Exemplary optional primer layers include acrylic latex or vinyl primers. The primer may include color pigments, if desired. Preferred primers have a 60-degree gloss value of less than about 15, more preferably less than about 10, and optimally less than about 5 percent. Preferred primers have a pigment volume concentration (PVC) greater than about 40%.

Other exemplary coating compositions for use under the coatings of this invention include those compositions and systems described in U.S. Patent Application Publication Nos. US 2007/0259166 A1 and US 2007/0259188 A1, and International Patent Application Nos. WO 2007/090132 A1 and WO 2007/089807 A1.

In certain aspects, the coating composition or paint formulation comprises a multistage latex polymer, which is made using discrete, sequential charges of two or more monomers or monomer mixtures, or is made using a continuously-varied charge of two or more monomers. Exemplary methods for making a multistage latex are disclosed in PCT International Publication No. WO/2013/090341, U.S. Patent Publication Nos. 2017/0247565, 2016/0145460 A1, 2014/030318, 2007/0110981, 2006/0135686 2006/0135684, the disclosures of the methods of making multistage latex compositions and multistage latex compositions in the foregoing being incorporated by reference in their entirety herein.

In certain embodiments, multistage latex polymers of the present invention are typically made using seed particles as a nucleating agent for polymerization. Such seed particles may be in the form of inorganic particulate seed (e.g., clay or glass particles), preformed particulate polymer seed (latex or non-latex polymer seed), or particulate seed polymer formed in situ. Polymer seed can be an emulsion polymerized polymer seed, but does not encompass polymeric surfactant. In certain embodiments, seed particles are used in an amount of no more than 10 wt-%, or no more than 5 wt-%, based on latex polymer solids in the final latex.

Herein whether inorganic particulate seed, preformed particulate polymer seed, or particulate seed polymer formed in situ, such seed particles will not be deemed to provide a stage of a multistage latex polymer or to provide a basis for designating a single stage polymer made using such seed polymer as a multistage latex polymer.

In certain embodiments, the multistage latex polymer has at least one measured Tg and at least one calculated Tg (which are not alternative representations of the same glass transition). Typically, the measured Tg corresponds to a first monomer feed and the calculated Tg corresponds to a second, and/or subsequent, monomer feed.

The Tg of a particular stage, or combination of stages, can be estimated (i.e., calculated using the Fox equation). For example, for a polymer formed from two monomers in a particular stage, the theoretical Tg may be calculated using the Fox equation as follows:

1/Tg=Wa/Tga+Wb/Tgb

wherein: Tga and Tgb are the respective glass transition temperatures in Kelvin of homopolymers made from monomers “a” and “b”; and Wa and Wb are the respective weight fractions of polymers “a” and “b”.

When additional monomer feeds “c” and “d” and so on are employed, additional fractions Wc/Tgc, Wd/Tgd and so on are added to the right-hand side of the above equation. Unless indicated otherwise, the “calculated” stage or copolymer Tg's referenced herein are calculated using the Fox equation. Also, the calculation is based on all of the monomers that are reacted together to form a stage, and not upon merely a portion of such monomers.

The value of Tg of the monomers used to estimate the polymer Tg are based on literature values. Typically, there is some variation of the Tg values of the homopolymers of monomers listed in such literature. For example, the Tg of the homopolymer of 2-ethyl hexyl acrylate has various literature values from −55° C. to −85° C. The difference arises from the test method used to measure the Tg. The differences also arise from influence of comonomers polymerized together. For the purposes of this disclosure, the values used for the homopolymer Tg of certain monomers, particularly monomers used in the examples are listed herein (e.g., in the Materials Table in the Examples Section). Alternatively, the method of determining the Tg of a homopolymer can be determined using the DSC procedure described in the Examples Section, particularly if the literature values are significantly different (e.g., the literature values vary by at least 15° C.). If the literature values vary by less than 15° C., then use the lower literature value.

If an emulsion polymerized ethylenically unsaturated monomer component (e.g., a monomer mixture used to form a higher Tg stage or a lower Tg stage) includes more than 5 wt-% of one or more monomers not having a homopolymer Tg (e.g., because the monomer cannot be homopolymerized), then instead of relying on the Fox equation, a single-stage reference latex can be made using the same overall monomer composition as the emulsion polymerized ethylenically unsaturated monomer component and the actual Tg measured using DSC. If the emulsion polymerized ethylenically unsaturated component includes 5 wt-% or less of one or more monomers not having a homopolymer Tg, then the one or more such monomers can be ignored and the Tg determined by the Fox equation.

In certain embodiments, the multistage latex polymer is a gradient latex polymer (i.e., gradient Tg latex polymer). Typically, a gradient Tg latex polymer will have a DSC (differential scanning calorimetry) curve that exhibits no Tg inflection points, and could be said to have an essentially infinite number of Tg stages. For example, one may start with a high Tg monomer feed and then at a certain point in the polymerization start to feed a low Tg soft stage monomer composition into the high Tg hard stage monomer feed. The resulting multistage latex polymer will have a gradient Tg from high to low. In other embodiments, it may be favorable to feed a high Tg hard stage monomer composition into a low Tg soft stage monomer composition. A gradient Tg polymer may also be used in conjunction with multiple Tg polymers.

For gradient Tg latex polymers, a Tg differential may be determined by using the Fox equation to calculate the theoretical Tg for a copolymer made from the monomer feed at the start of polymerization and comparing the result to the calculated theoretical Tg for a copolymer made from the second feed. Such gradient Tg can result from the second monomer feed being combined into the first monomer feed to form a gradient architecture, or ultimately result from two monomer feeds being combined at differential rates (e.g., the rate of one monomer feed increases while the rate of a second monomer feed decreases). For multistage polymers made using such a gradient Tg approach, the Tg differential in the calculated Tg of monomers fed at the start of polymerization compared to monomers fed at the end of polymerization of the gradient-fed monomers preferably is at least 20° C., at least 30° C., at least 35° C., at least 40° C., at least 50° C., at least 60° C., or at least 70° C.

In certain embodiments, there may be a discrete measurable Tg of an otherwise gradient Tg latex polymer, such discreet Tg is typically corresponding to the polymer resulting from polymerization of the first monomer feed, or to a mixture of the first monomer feed and a small amount of the second monomer feed.

In certain aspects, the multistage latex described herein can be made using sequential monomer feed and continuously varying monomer feed techniques. In a sequential monomer feed process, a first monomer or monomer mixture is fed during the early stages of polymerization, and a second monomer (e.g. a different monomer, a different combination of monomers, or a mixture of monomers present in different ratios than in the first monomer mixture) is fed during later stages of polymerization. In a varying monomer feed process, a first monomer composition is fed, followed by the addition of a second monomer at certain points in the polymerization process, and at different speeds. By controlling the type of monomers selected for the feed process, a multistage latex suitable for low VOC, coating compositions or paints may be formed, and the latex preferably provides excellent performance characteristics, such as, for example, block resistance, scrub resistance, tack resistance, and the like, for such coating or paint formulations.

In certain aspects, the multistage latex composition described herein is made by a sequential monomer feed process. In an aspect, polymerization begins with a “high” Tg monomer feed followed by a “low” Tg monomer feed, or vice-versa. In a preferred aspect, polymerization begins with a “high” Tg monomer feed, followed by a “low” Tg monomer feed.

In certain aspects, the multistage latex composition described herein is made using varying monomer feeds. The resulting polymer will typically have a DSC curve that exhibits no Tg inflection points, and could be said to have an essentially infinite number of Tg stages. The resultant multistage latex may have a gradient Tg from high to low, or vice-versa, depending on the order that monomers of high Tg are fed into the reaction.

In a preferred aspect, the multistage latex described herein is made by a sequential monomer feed process using at least two distinct feeds of monomers. In an aspect, a high Tg stage (e.g. a hard stage) is fed first into a reactor vessel, and a low Tg stage (e.g. a soft stage) is added at a later stage in the process. A multistage latex may be formed, and after coalescence, the composition will typically display two distinct Tg values, or at least one Tg corresponding to the monomer stage present at higher concentration. Without being bound to theory, it is expected that no distinct Tg will be observed or detected by DSC for a monomer or monomer mixture in a particular stage that is present in very small quantities relative to the other monomer or monomer mixture. The Tg values can also overlap such that no distinct Tg will be observed or detected by DSC even for different monomer compositions.

It may be advantageous to use a gradient Tg latex polymer made using continuously varying monomer feeds. The resulting polymer will typically have a DSC curve that exhibits no Tg inflection points, and could be said to have an essentially infinite number of Tg stages. For example, one may start with a high Tg monomer composition and then at a certain point in the polymerization start to feed a low Tg soft stage monomer composition into the reactor with the high Tg hard stage monomer feed (e.g., at different rate) or into the high Tg hard stage monomer feed. The resulting multistage latex polymer will have a gradient Tg from high to low. A gradient Tg polymer may also be used in conjunction with multiple Tg polymers. As an example, a high Tg monomer feed (F1) and a low Tg monomer feed (F2) can be prepared. The process would begin by adding feed F1 into the latex reactor vessel and initiating polymerization. After a certain period during the F1 feed, the feed F2 is added into F1 wherein the F2 feed rate is faster than the overall feed rate of F1+F2 into the reactor vessel. Consequently, once the F2 feed into F1 is complete, the overall Tg of the F1+F2 monomer feed blend will be a lower Tg “soft stage” monomer composition.

In certain aspects, by controlling the monomers used for each stage of the sequential monomer feed process, a multistage latex composition with optimal minimum film forming temperature (MFFT) is obtained. The MFFT is the minimum temperature at which the latex composition will form a continuous film, e.g. the temperature below which coalescence does not occur. The MFFT of the multistage latex composition as described herein is preferably less than about 25° C., more preferably less than about 20° C. A base paint or other paint that includes the multistage latex described herein preferably has MFFT of less than about 20° C., more preferably less than about 10° C.

In an aspect, the multistage latex optionally includes a seed phase, e.g. a relatively small monomer or polymer particle, but the seed is not required, nor essential for preparation or optimal performance of the multistage latex when used in a coating composition or paint formulation. A single stage latex made using a seed phase in a conventional amount (e.g., an amount of no more than 10 wt-%, or no more than 5 wt-%, based on latex polymer solids in the final latex) is not a multistage latex polymer.

In an aspect, the relative positions of the first and second phases may be internal and external respectively, or vice-versa. In another aspect, the first and second phases may be neighboring or adjacent. Without being bound by theory, it is believed that the relative position of the stages of the multistage latex is influenced by the method used to make the latex. In some embodiments, by controlling the monomers used in each stage of the sequential monomer feed process, the multistage latex described herein will contain about 10 wt % to 50 wt %, preferably about 20 to 40 wt %, more preferably about 25 to 35 wt % of monomers of the first stage, e.g. high Tg or hard stage monomers, and about 50 wt % to 90 wt %, preferably about 60 to 80 wt %, more preferably about 65 to 75 wt % of monomers of the second stage, e.g. low Tg or soft stage monomers, based on the total weight of the monomers used to form the latex polymer.

In certain aspects, the multistage latex described herein preferably includes at least two polymer portions, e.g. a first stage and a second stage, with different Tg values, where the difference in Tg (ΔTg) is at least about 35° C., preferably at least about 60° C., more preferably at least about 65° C. In certain aspects, the ΔTg is less than about 200° C., in some aspects less than about 150° C., and in some other aspects less than about 100° C. In an embodiment, where the multistage latex is intended for use in a pigmented high gloss or semi-gloss paint, the difference in Tg (ΔTg) is preferably at least about 35° C., preferably at least about 60° C., more preferably at least about 65° C., and less than about 200° C., in some aspects less than about 150° C., and in some other aspects less than about 100° C.

In certain aspects, the multistage latex described herein preferably includes at least two polymer portions, e.g. a first stage and a second stage, with different Tg values, where the difference in Tg (ΔTg) is between about 35° C. and about 200° C., preferably at least about 60° C. to about 200° C., more preferably at least about 65° C. to about 200° C. In an embodiment, where the multistage latex is intended for use in a pigmented high gloss or semi-gloss paint, the difference in Tg (ΔTg) is between about 35° C. and about 200° C., preferably at least about 60° C. to about 200° C., more preferably at least about 65° C. to about 200° C.

In certain aspects, the invention described herein includes a multistage latex polymer having at least a first stage and a second stage. In an aspect, the first stage and second stage of the multistage latex separately and preferably include one or more, typically two or more, ethylenically unsaturated monomers. In another aspect, the first and second stage of the multistage latex separately and preferably include one or more, more preferably two or more, polymerization products of ethylenically unsaturated monomers, such as, for example, (meth)acrylates (e.g. alkyl and alkoxy (meth)acrylates), cycloaliphatic (meth)acrylates (e.g. cyclohexyl (meth)acrylate), aryl (meth)acrylates (e.g., benzyl (meth)acrylate), vinyl esters of saturated carboxylic acids, monoolefins, conjugated dienes, polyfunctional acrylates, and the like, styrene, methyl methacrylate, alkyl(meth)acrylates, vinyl acetate, acrylonitrile, vinyl chloride, other suitable vinyl monomers and the like. In an embodiment, the first stage or second stage of the multistage latex optionally includes one or more polyfunctional (meth)acrylate monomers (e.g., one or more multi-ethylenically unsaturated (meth)acrylates). In an embodiment, the first stage and second stage separately and preferably also include one or more ethylenically unsaturated carboxy-functional amide monomers, e.g., ureido-functional monomers, such as monomers formed as the product of the reaction between aminoalkyl alkylene urea (e.g., amino ethylene urea, for example) with an ethylenically unsaturated carboxylic acid or anhydride (e.g., maleic anhydride, for example).

Exemplary ethylenically unsaturated monomers for use in making the latex polymer include, for example, acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide (DAAM), acrylamide, methacrylamide, methylol (meth)acrylamide, styrene, a-methyl styrene, vinyl toluene, vinyl acetate, vinyl propionate, allyl methacrylate, and mixtures thereof. Preferred monomers include methyl methacrylate (homopolymer Tg=104.9° C.), methacrylic acid (Tg=185° C.), diacetone acrylamide (Tg=64.9° C.), n-butyl acrylate (Tg=54° C.), n-butyl methacrylate (Tg=20° C.), and the like.

Exemplary polyfunctional acrylates include, for example, di-, tri- and tetra-functional acrylates such as hexanediol diacrylate (HDODA), dipropylene glycol diacrylate (DPGDA), propoxylated glyceryl triacrylate (GPTA), pentaerythritol tetraacrylate, dipentaerythritol tetraacrylate, mixtures thereof, and the like. Preferred polyfunctional acrylate monomers include pentaerythritol tetraacrylate, dipentaerytrithol tetraacrylate, and the like. Exemplary polyfunctional methacrylates include 1,3-butanediol dimethacrylate, 1,6-hexanediol dimethacrylate, diurethane dimethacrylate, ethylene glycol dimethacrylate, mixtures thereof, and the like.

Exemplary ureido-functional monomers include, for example, monomers with —NR—(C═O)—NH— functionality, where R may be H, substituted or unsubstituted C₁-C₁₀ alkyl, substituted or unsubstituted C₃-C₆ cycloalkyl or heteroalkyl, and the like. Without being bound by theory, ureido-functional monomers are believed to promote the wet adhesion of a paint formulation to a substrate, where the formulation includes the multistage latex described herein.

In an embodiment, the first or second stage, or both, of the multistage latex each separately and preferably include one or more ethylenically unsaturated monomers, the ethylenically unsaturated monomers preferably comprising one or more ureido-functional monomers. For example, in a preferred embodiment, the first stage includes a first mixture comprising two or more, preferably three or more, more preferably all of the following monomers: methyl methacrylate, butyl acrylate, methacrylic acid, DAAM and a ureido-functional monomer. In a preferred embodiment, the second stage includes two or more, preferably three or more, more preferably all of the following monomers: methyl methacrylate, butyl acrylate, DAAM, methacrylic acid, and a ureido-functional monomer.

In an embodiment, the first or second stage, or both, of the multistage latex each separately and preferably include about 90 to 99 wt %, more preferably about 94 to 96 wt %, and most preferably about 97 to 98 wt % of one or more ethylenically unsaturated monomers, the ethylenically unsaturated monomers preferably comprising up to about 5 wt %, more preferably about 1 to 4 wt %, and most preferably about 2 to 3 wt % of one or more ureido-functional monomers, based on the total weight of the monomers in the first or second stage respectively. For example, in a preferred embodiment, the first stage includes a first mixture comprising about 65-75 wt % methyl methacrylate, about 18-28% butyl acrylate, about 0.5-3 wt % methacrylic acid, about 2-4 wt % DAAM, and about 0.5-3 wt % ureido-functional monomer, based on the total weight of the monomers in the first mixture. In a preferred embodiment, the second stage includes a second mixture comprising about 25-35 wt % methyl methacrylate, about 55-65 wt % butyl acrylate, about 2-4 wt % DAAM, about 0.5-3 wt % methacrylic acid, and about 0.5-3 wt % ureido-functional monomer, based on the total weight of the monomers in the second mixture.

In certain aspects, the multistage latex described herein includes, optionally and preferably, a fluorosurfactant. As used herein, the term “fluorosurfactant” refers to synthetic organofluorine compounds with multiple fluorine atoms. Such compounds can be polyfluorinated, perfluorinated (e.g. fluorocarbons), or partially fluorinated, and typically include a hydrophilic head and a fluorinated/hydrophobic tail. Suitable fluorosurfactants may be anionic or nonionic. Commonly used fluorosurfactants include, for example, fluoroalkanes, perfluoroalkanes, their derivatives, and the like. In an aspect, short chain fluorinated compounds are preferred, such as, for example, C1-C10 fluorinated compounds. In a preferred aspect, the fluorosurfactant is an anionic C6-fluorocarbon compound, and is preferably substantially free of PFOS and PFOA, and more preferably, essentially free of PFOS and PFOA. In a preferred aspect, the multistage latex preferably includes up to about 0.5 wt %, more preferably about 0.1 to 0.3 wt % fluorosurfactant, based on the total weight of the multistage latex composition.

In some aspects, the multistage latex polymer is derived from one or more monomers capable of crosslinking by a keto-hydrazide crosslinking. The keto-hydrazide crosslinking reaction refers to the reaction of a carbonyl pendant group on a dispersed polymer backbone in the presence of a diamines, triamines or polyamines, specifically where this diamine is a dihydrazide, this triamine is a trihydrazide, and the polyamine is a polyhydrazide. The carbonyl pendant group may comprise, for example, aldehydes (RCHO) or ketones (RCOR′), which are both reactive varieties of the more general carbonyl functional group, and have a carbon-oxygen double-bond (C═O). The crosslinking reaction can occur within the same particle (intra-particle) or it can occur at the interface between particles (inter-particle).

In some aspects, the multistage latex polymer is derived from one or more monomers capable of crosslinking by a keto-hydrazide crosslinking reaction, wherein the multistage latex polymer is derived from one or more monomers having at least one unsaturated double bond and at least one amide group. In some aspects, the multistage latex polymer is derived from one or more monomers capable of crosslinking by a keto-hydrazide crosslinking reaction comprising diacetone acrylamide (DAAM). DAAM is a functional monomer that has a carbonyl group within the molecule. Without wishing to be bound by theory, it is believed that the keto-hydrazide reaction between the structural units derived from one or more monomers and the hydrazide component is acid catalyzed and favored by the loss of water and the simultaneous decrease in pH arising from the evaporation of ammonia or amines during the film-forming process. Preferred multistage latex polymers are derived from at least about 0.5 wt. % of the one or more monomers capable of crosslinking by the keto-hydrazide crosslinking reaction, more preferably about 0.5 wt % to about 7.5 wt. %, and most preferably about 2 wt. % to about 5 wt. % based on the total weight of monomers used to form the latex polymer. In certain aspects, the one or more monomers capable of crosslinking by the keto-hydrazide crosslinking reaction have at least one unsaturated double bond and at least one amide group, in some other aspects the one or more monomers comprise aldehyde or ketone functional reactive monomers, and in some other aspects the one or more monomers comprise at least one unsaturated double bond, at least one amide group, and one or more monomers that comprise aldehyde or ketone functional reactive monomers. In some preferred aspects, the one or more monomers capable of crosslinking by the keto-hydrazide crosslinking reaction comprise diacetone acrylamide (DAAM).

In certain aspects, the multistage latex polymer is crosslinked after polymerization by a keto-hydrazide crosslinking reaction. Carbohydrazide and dihydrazide components are capable of promoting crosslinking of the multistage latex polymer by a keto-hydrazide crosslinking reaction. Carbohydrazide and dihydrazides have a nitrogen-nitrogen covalent bond with four substituents with at least one of the substituents being an acyl group. The general structure for a hydrazide is E(═O)NR—NR₂, where the R's are frequently hydrogens. Hydrazides can be further classified by the atom attached to the oxygen: carbohydrazides (R—C(═O)—NH—NH₂), sulfonohydrazides (R—S(═O)—NH—NH₂), and phosphonic hydrazides (R—P(═O)—NH—NH₂). Carbohydrazide has two NHNH₂ groups with a single C═O bond. Dihydrazides are symmetrical molecules having two reactive C═ONRNR₂ groups, where the R's are frequently hydrogens. It is also contemplated that the dihydrazides could also be sulfonodihydrazides and phosphonic dihydrazides.

In certain aspects, the multistage polymer latex is crosslinked after polymerization with adipic acid dihydrazide, carbohydrazide, mixtures thereof, and the like. Other exemplary dihydrazides, trihydrazides and polyhydrazides that are contemplated to perform the keto-hydrazide crosslinking reaction individually, or as mixtures, have a C0-C10 backbone between two or more reactive C═ONHNH₂ groups as represented by the following formula:

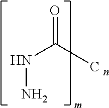

wherein n is an integer between 0 and 10, and m is an integer between 2 and 10. For example, oxalyl dihydrazide has n=0, m=2 and does not have a carbon backbone between the two reactive C═ONHNH₂ groups, succinic dihydrazide has n=2, m=2 and has a straight C2 backbone, adipic acid dihydrazide has a straight C4 backbone, isophthalic dihydrazide has a C6 benzene ring backbone, azelaic dihydrazide has a straight C7 backbone, sebacic dihydrazide has a straight C8 backbone, and dodecanedioic dihydrazide has a straight C10 backbone.

It is also contemplated that other exemplary dihydrazides, trihydrazides and polyhydrazides can perform the keto-hydrazide crosslinking reaction individually, or as mixtures, wherein an R group replaces the Cn, C═O, or both the Cn and C═O in the formula above between two or more reactive —HNH₂ groups. For example, the R group can be a phenyl replacing the Cn for metallitic acid trihydrazide. Other exemplary contemplated trihydrazides include cyanuric trihydrazide, phosphorothioic trihydrazide, and the like.

In certain aspects, the amount of the one or more monomers capable of crosslinking by a keto-hydrazide crosslinking reaction relative to the amount of the carbohydrazide, adipic acid dihydrazide, other dihydrazides, or mixtures thereof, is a mole ratio of about 1:0.33 to about 1:1.36. For example, for a multistage latex polymer derived from DAAM as the monomer capable of keto-hydrazide crosslinking with carbohydrazide, the amount of DAAM relative to the amount of carbohydrazide is a mole ratio of about 1:0.33 to about 1:1.36. In another example, of a multistage latex polymer derived from DAAM as the monomer capable of keto-hydrazide crosslinking with adipic acid dihydrazide, the amount of DAAM relative to the amount of adipic acid dihydrazide is a mole ratio of about 1:0.33 to about 1:1.36. In yet another example, of a multistage latex polymer derived from DAAM as the monomer capable of keto-hydrazide crosslinking with two or more dihydrazides, the amount of DAAM relative to the amount of the two or more dihydrazides is a mole ratio of about 1:0.33 to about 1:1.36.

In certain aspects, the amount of carbohydrazide, adipic acid dihydrazide, other dihydrazides, or mixtures thereof, present may be about 17 to about 70 parts per 100 parts (by weight) of the one or more monomers capable of crosslinking by a keto-hydrazide crosslinking reaction. For example, for a multistage latex polymer derived from DAAM as the monomer capable of keto-hydrazide crosslinking with adipic acid dihydrazide, the amount of the adipic acid dihydrazide may be present in an amount of about 17 to about 70 parts to 100 parts of DAAM (by weight). In another example, for a multistage latex polymer derived from DAAM as the monomer capable of keto-hydrazide crosslinking with carbohydrazide, the amount of the carbohydrazide may be present in an amount of about 17 to about 70 parts to 100 parts of DAAM (by weight). In yet another example, for a multistage latex polymer derived from DAAM as the monomer capable of keto-hydrazide crosslinking with two or more dihydrazides, the amount of the two or more dihydrazides may be present in an amount of about 17 to about 70 parts to 100 parts of DAAM (by weight).

In certain aspects, the compositions may comprise a photoinitiator, such as benzophenone or a methyl-substituted benzoylbenzoate being preferred.

Compositions of this embodiment preferably include a multistage latex polymer in an amount of at least 10 weight %, more preferably at least 25 weight %, and even more preferably at least 35 weight %, based on total solids of the composition. Compositions of this embodiment preferably include a multistage polymer in an amount of less than 100 weight %, more preferably less than 85 weight %, and even more preferably less than 80 weight %, based on the total solids of the composition.

In some aspects, the total solids range for the coating compositions is at least 20 weight %, in some other aspects at least 25 weight %, in some other aspects at least 30 weight %, in some other aspects at least 35 weight %, and in some other aspects at least 40 weight %. In some aspects, the total solids range for the coating composition is less than 55 weight %, in some other aspects less than 50 weight %, and in some other aspects less than 45 weight %.

In some aspects of a clear coating composition that does not have any added pigment, the total solids range for the coating compositions is at least 20 weight %, more preferably at least 22.5 weight %, more preferably at least 25 weight %, more preferably at least 27.5 weight %, and even more preferably at least 30 weight %. In some aspects, the total solids range for the clear coating composition that does not have any added pigment is less than 55 weight %, more preferably less than 50 weight %, more preferably less than 45 weight %, more preferably less than 40 weight %, and even more preferably less than 35 weight %.

In some aspects of a pigmented coating composition, the total solids range for the coating compositions is at least 25 weight %, more preferably at least 30 weight %, more preferably at least 35 weight %, more preferably at least 40 weight %, and even more preferably at least 45 weight %. In some aspects, the total solids range for the pigmented coating composition is less than 55 weight %, more preferably less than 53.5 weight %, more preferably less than 52 weight %, more preferably less than 51 weight %, and even more preferably less than 50 weight %.

In some aspects, the multistage latex polymer includes silane functionality, which may for example be provided by carrying out chain-growth polymerization in the presence of a silane coupling agent that contains a functional group capable of copolymerizing with, and which copolymerizes with, a monomer from which the multistage latex polymer is formed. Exemplary such silanes include monomeric, dipodal and oligomeric silanes containing a vinyl, allyl, (meth)acrylate or other ethylenically unsaturated group, or a mercapto group. Representative silanes include olefinic silanes such as vinyltrialkoxysilane, vinyltriacetoxy-silane, alkylvinyldialkoxysilane, hexenyltrialkoxysilane and the like, allyl silanes such as allyltrialkoxysilane, silane acrylates such as (3-acryloxypropyl)trimethoxysilane, γ-methacryloxypropyltrimethoxysilane and the like, and mercapto silanes such as 3-mercaptopropyltrimethoxysilane, 3-mercaptopropyltriethoxysilane, s-(octanoyl)mercaptopropyltriethoxysilane, 3-thiocyanatopropyltriethoxysilane, 3-mercaptopropylmethyldimethoxysilane, bis[3-(triethoxysilyl)propyl]-tetrasulfide, and bis[3-(triethoxysilyl)propyl]-disulfide, and combinations thereof. Commercially available silanes which may be reacted into the latex polymer during polymer formation include SILQUEST™ A-151 vinyl triethoxysilane, A-171 vinyl trimethoxysilane, A-172 vinyl-tris-(2-methoxyethoxy) silane, A-174 γ-methacryloxypropyltrimethoxysilane, and A-2171 vinyl methyldimethoxysilane, each available from Momentive Performance Materials Inc. Silanes with multiple functionality may also be used such as DYNASYLAN™ HYDROSIL 2929, an amino/methacrylate functional silane from Degussa.

The multistage latex polymer may also be made silane-functional by including a silane functional additive into the multistage latex polymer, such as in a polymeric surfactant incorporated into the multistage latex polymer by association, entanglement or covalent attachments.

The multistage latex polymer may also be made silane-functional by combining the polymer with a silane coupling agent having a functional group (e.g., an epoxy, amino or isocyanato group) and reacting the functional group with functionality (e.g., acetoacetoxy, carboxy or amino functionality) on the already-formed latex polymer. Suitable epoxy-functional silanes include silanes having the formula:

R₁Si(R₂)₃₋ₙ(OR₃)ₙ,

where n is 1, 2, or 3, and the R₁ group contains at least one epoxy group and is an alkyl, cycloalkyl, phenyl, cycloalkylalkyl, alkenylcycloalkyl, alkenylphenyl (e.g., benzyl), or phenylalkyl (e.g., tolyl). Each R₂ group is independently hydrogen, alkyl, cycloalkyl, phenyl, cycloalkylalkyl, alkenylcycloalkyl, alkenylphenyl (e.g., benzyl), phenylalkyl (e.g., tolyl), or a silane oligomer, wherein each R₂ group can optionally include OR₃ groups or epoxy functionality. Each R₃ group is independently hydrogen, alkyl, cycloalkyl, phenyl, cycloalkylalkyl, alkenylcycloalkyl, alkenylphenyl (e.g., benzyl), or phenylalkyl (e.g., tolyl). Preferred epoxy-functional silanes have an weight average molecular weight (“Mw”) of from about 140 to about 500 g/mole, more preferably from about 150 to about 300. In one preferred embodiment, the Mw does not exceed a maximum of about 190 to about 250, n is 1 or 2, R₁ is an alkyl group of 3 to 8 carbon atoms containing no more than one epoxy group, and R₂ is a methoxy or ethoxy group.

Exemplary epoxy-functional silanes include ß-(3,4 epoxycyclohexyl)-ethyltrimethoxysilane (available from Mitsubishi International Corporation as KBM303), r-glycidoxypropyl-trimethoxysilane (available from Mitsubishi International Corporation as KBM403), r-glycidoxypropyl-methyldiethoxysilane (available from Mitsubishi International Corporation as KBE402), glycidoxypropyltrimethoxysilane (available from Dow Corning as Z-6040), glycidoxypropyltriethoxysilane (available from Dow Corning as Z-6041), γ-glycidoxypropyltriethoxysilane (available from GE Silicones as SILQUEST™ A-187), glycidoxypropylmethyldimethoxysilane (available from Dow Corning as Z-6044), glycidoxy-propylmethyldiethoxysilane (available from Dow Corning as Z-6042), and epoxycyclohexyl-ethyltrimethoxysilane (available from Dow Corning as Z-6043), 5,6-epoxyhexyltriethoxysilane (available from Gelest, Inc. as SIE4675.0), hydrolyzates of the above and the like, and combinations thereof.

Suitable amino-functional silanes include silanes having the formula:

R₁—Si(R₂)₃₋ₙ(OR₃)ₙ

where n is 1, 2, or 3, and the R₁ group contains at lest one amino group and is alkyl, cycloalkyl, phenyl, cycloalkylalkyl, alkenylcycloalkyl, alkenylphenyl (e.g., benzyl), or phenylalkyl (e.g., tolyl). Each R₂ group is independently hydrogen, alkyl, cycloalkyl, phenyl, cycloalkylalkyl, alkenylcycloalkyl, alkenylphenyl (e.g., benzyl), or phenylalkyl (e.g., tolyl), or a silane oligomer, wherein each R₂ group can optionally include OR₃ groups or amino functionality. Each R₃ group is independently hydrogen, alkyl, cycloalkyl, phenyl, cycloalkylalkyl, alkenylcycloalkyl, alkenylphenyl (e.g., benzyl), or phenylalkyl (e.g., tolyl). Preferred amino-functional silanes have an Mw from about 140 to about 500, more preferably from about 150 to about 300. In one embodiment, it is preferred that the Mw not exceed a maximum of about 190 to about 250, wherein n is 1 or 2, R₁ is an alkyl group having from 3 to 8 carbon atoms and containing no more than one amino group, and R₂ is a methoxy or ethoxy group.

Exemplary amino-functional silanes include trimethoxysilylpropyldiethylene-triamine, N-methylaminopropyltrimethoxysilane, aminoethylaminopropylmethyl-dimethoxysilane, aminoethylaminopropyltrimethoxysilane (available from Dow Corning as Z-6020), aminopropylmethyldimethoxysilane, aminopropyltrimethoxysilane, polymeric aminoalkylsilicone, aminoethylaminoethylaminopropyl-trimethoxysilane, N-methylamino-propyltrimethoxysilane, methylamino-propyltrimethoxysilane, aminopropylmethyl-diethoxysilane, aminopropyltriethoxysilane, 4-aminobutyltriethoxysilane, oligomeric aminoalkylsilane, m-aminophenyltrimethoxysilane, phenylaminopropyltrimethoxysilane, 1,1,2,4-tetramethyl-1-sila-2-azacyclopentane, aminoethylaminopropyltriethoxysilane, aminoethylaminoisobutylmethyldimethoxysilane, benzylethylenediaminepropyl-trimethoxysilane, hydrolyzates of the above and the like, and combinations thereof.

Practical considerations such as solubility, hydrolysis rate, compatibility with the coating composition, polymer stability, and the like, may be considered when selecting the structure and Mw of the silane and choosing whether to react the silane with a monomer from which the multistage latex polymer is formed, or to react the silane with functionality on the already-formed latex polymer. Both approaches may be used if desired. The coating composition may if desired also contain a separate silane coupling agent (e.g., a silane monomer, oligomer or polymer) or unreacted functional silane in order to augment or complement the performance of the silane-functional multistage polymer. Exemplary silane coupling agents include alkoxysilanes such as bis(triethoxysilylethane, 1,2 bis(trimethoxysilyl)decane, (trimethoxysilyl)ethane and bis[(3-methyldimethoxysilyl)propyl]-polypropylene oxide; carboxylate silanes such as carboxyethylsilanetriol sodium salt; hydroxy silanes such as bis(2-hydroxyethyl)-3-aminopropyl-triethoxysilane, triethoxysilylmethanol, N-(triethoxysilylpropyl)-o-polyethylene oxide urethane and N-(3-triethoxysilylpropyl)gluconamide; phosphine and phosphate silanes such as diethylphosphatoethyltriethoxysilane and 3-trihydroxysilylpropylmethylphosphonate, sodium salt; and sulfonate silanes such as 3-(trihydroxysilyl)1-1propane-sulfonic acid, and combinations thereof. The silane may also be a polymeric silane such as triethoxysilyl modified poly-1,2-butadiene From Gelest, Inc. and aminoalkyl silsesquioxane oligomers from Gelest, Inc.

Whether the multistage latex polymer is made silane-functional by reacting the silane into the polymer during polymer formation or onto the polymer after polymer formation, the disclosed coating compositions may, for example, contain at least about 0.2 weight %, at least about 0.5 weight %, or at least about 0.7 weight % silane, based on a comparison of the weight of silane starting material to the latex polymer weight. The multistage latex polymer may for example contain less than about 10 weight %, less than about 6 weight %, or less than about 4 weight % silane, based on the total resin solids.

Exemplary multistage latex polymer compositions contain at least two polymer stages of different glass transition temperatures (viz., different Tg values) and may be prepared via emulsion polymerization using many of the aforementioned monomers. In one preferred embodiment, the latex will include a first polymer stage (the “soft stage”) having a Tg less than 30° C., e.g., between about −65 and 30° C., more preferably between about −15 and 25° C., and most preferably between about −5 and 15° C. and a second polymer stage (the “hard stage”) having a Tg greater than 30° C., e.g., between about 30 and 230° C., more preferably between about 30 and 125° C., and most preferably between 60 and 100° C. The ratios of monomers in the disclosed multistage latex polymers may be adjusted to provide the desired level of “hard stage” or “soft stage”. In some aspects, the hard and soft Tg stages can be reversed for the respective core and shell.

The disclosed multistage latex polymer compositions preferably include about 5 to about 95 weight percent soft stage polymer morphology, more preferably about 50 to about 90 weight percent soft stage polymer morphology, and most preferably about 60 to about 80 weight percent soft stage polymer morphology based on total latex polymer weight. The disclosed multistage latex polymer compositions preferably include about 5 to 95 weight percent hard stage polymer morphology, more preferably about 10 to about 50 weight percent hard stage polymer morphology, and most preferably about 20 to about 40 weight percent hard stage polymer morphology based on total latex polymer weight.

For example, a soft stage may be introduced by providing a monomer composition containing 5 to 65 parts n-butyl acrylate, 20 to 90 parts n-butyl methacrylate, 0 to 55 parts methyl methacrylate, 0.5 to 5 parts (meth)acrylic acid, 0 to 20 parts DAAM and 0.1 to 2 parts olefinic silane. A hard stage may be introduced by providing a monomer composition including 0 to 20 parts butyl acrylate, 0 to 40 parts n-butyl methacrylate, 45 to 95 parts methyl methacrylate, 0.5 to 5 parts (meth)acrylic acid, 0 to 20 parts DAAM and 0.1 to 2 parts olefinic silane, wherein at least one of the soft and hard stages contains DAAM to achieve a multistage latex polymer having about 0.5 weight % to about 7.5 weight %, more preferably about 1.9 weight % to about 5.0 weight %, DAAM based on the total weight of the monomers used to form the multistage latex polymer. The olefinic silane may be reacted into either or both of the soft and hard stages. Silane functionality may instead or in addition be reacted onto the already-formed multistage latex polymer via reaction with functionality on either or both of the soft and hard stages.

The aforementioned multistage latex polymers are illustrative and other multistage latex polymers may be used in the practice of this invention. For example, the multistage latex polymer may be prepared in the presence of an alkali-soluble resin, more preferably a high Tg alkali-soluble resin. Alkali-soluble resins may be prepared by making a polymer with acrylic or methacrylic acid or other polymerizable acid monomer (usually at greater than 7 weight %) and solubilizing the polymer by addition of ammonia or other base. Examples of suitable alkali-soluble resins include JONCRYL™ 675 and JONCRYL 678 oligomer resins, available from BASF. A low Tg soft stage monomer composition or gradient Tg composition could then be polymerized in the presence of the hard stage alkali-soluble polymer to prepare a multistage latex polymer. Another exemplary process for preparing alkali soluble supported polymers is described in U.S. Pat. No. 5,962,571. If desired, the disclosed coating compositions may also contain non-silane-functional latex polymers, including non-silane-functional multistage latex polymers.

The disclosed multistage latex polymers may be stabilized during synthesis by one or more nonionic, anionic, or cationic emulsifiers (e.g., surfactants), used either alone or together. Examples of suitable nonionic emulsifiers include tert-octylphenoxyethylpoly(39)-ethoxyethanol, dodecyloxypoly(10)ethoxyethanol, nonylphenoxyethyl-poly(40)ethoxyethanol, polyethylene glycol 2000 monooleate, ethoxylated castor oil, fluorinated alkyl esters and alkoxylates, polyoxyethylene (20) sorbitan monolaurate, sucrose monococoate, di(2-butyl)-phenoxypoly(20)ethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with ethylene oxide, N-polyoxyethylene(20)lauramide, N-lauryl-N-polyoxyethylene(3)amine and poly(10)ethylene glycol dodecyl thioether thioether. Examples of suitable anionic emulsifiers include sodium lauryl sulfate, sodium dodecylbenzenesulfonate, potassium stearate, sodium dioctyl sulfosuccinate, sodium dodecyldiphenyloxide disulfonate, nonylphenoxyethylpoly(1)ethoxyethyl sulfate ammonium salt, sodium styrene sulfonate, sodium dodecyl allyl sulfosuccinate, linseed oil fatty acid, sodium, potassium, or ammonium salts of phosphate esters of ethoxylated nonylphenol or tridecyl alcohol, sodium octoxynol-3-sulfonate, sodium cocoyl sarcocinate, sodium 1-alkoxy-2-hydroxypropyl sulfonate, sodium alpha-olefin (C₁₄-C₁₆)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid and the sodium salt of tert-octylphenoxyethoxypoly(39)ethoxyethyl sulfate.

One or more water-soluble free radical initiators typically are used in the chain-growth polymerization of the multistage latex polymer. Initiators suitable for use in the coating compositions will be known to persons having ordinary skill in the art or can be determined using standard methods. Representative water-soluble free radical initiators include hydrogen peroxide; tert-butyl peroxide; alkali metal persulfates such as sodium, potassium and lithium persulfate; ammonium persulfate; and mixtures of such initiators with a reducing agent. Representative reducing agents include sulfites such as alkali metal metabisulfite, hydrosulfite, and hyposulfite; sodium formaldehyde sulfoxylate; and reducing sugars such as ascorbic acid and isoascorbic acid. The amount of initiator is preferably from about 0.01 to about 3 weight %, based on the total amount of monomer. In a redox system the amount of reducing agent is preferably from 0.01 to 3 weight %, based on the total amount of monomer. The polymerization reaction can be performed at a temperature in the range of from about 10 to about 100° C.

The disclosed coating compositions may contain a variety of adjuvants which will be familiar to persons having ordinary skill in the art or which can be determined using standard methods. For example, the coating compositions may contain one or more optional coalescents to facilitate film formation. Exemplary coalescents include glycol ethers such as EASTMAN™ EP, EASTMAN DM, EASTMAN DE, EASTMAN DP, EASTMAN DB and EASTMAN PM from Eastman Chemical Co. and ester alcohols such as TEXANOL™ ester alcohol from Eastman Chemical Co. Preferably, the optional coalescent is a low VOC coalescent such as is described in U.S. Pat. No. 6,762,230 B2. The coating compositions preferably include a low VOC coalescent in an amount of at least about 0.5 weight %, more preferably at least about 1 weight %, and yet more preferably at least about 2 weight %. The coating compositions also preferably include a low VOC coalescent in an amount of less than about 10 weight %, more preferably less than about 6 weight %, and yet more preferably less than about 4 weight %, based on the total weight of the coating composition.

The disclosed coating compositions may include a surface-active agent (surfactant) that modifies the interaction of the coating composition with the substrate or with a prior applied coating. The surface-active agent affects qualities of the composition including how the composition is handled, how it spreads across the surface of the substrate, and how it bonds to the substrate. In particular, the agent can modify the ability of the composition to wet a substrate. Surface-active agents may also provide leveling, defoaming or flow control properties, and the like. If used, the surface-active agent is preferably present in an amount of less than 5 weight %, based on the total coating composition weight. Exemplary surface-active agents include those available under the trade designations STRODEX™ KK-95H, STRODEX PLF100, STRODEX PKOVOC, STRODEX LFK70, STRODEX SEK50D and DEXTROL™ OC50 from Dexter Chemical L.L.C. of Bronx, N.Y.; HYDROPALAT™ 100, HYDROPALAT 140, HYDROPALAT 44, HYDROPALAT 5040 and HYDROPALAT 3204 from Cognis Corp. of Cincinnati, Ohio; LIPOLIN™ A, DISPERS™ 660C, DISPERS 715W and DISPERS 750W from Degussa Corp. of Parsippany, N.J.; BYK™ 156, BYK 2001 and ANTI-IERRA™ 207 from Byk Chemie of Wallingford, Conn.; DISPEX™ A40, DISPEX N40, DISPEX R50, DISPEX G40, DISPEX GA40, EFKA™ 1500, EFKA 1501, EFKA 1502, EFKA 1503, EFKA 3034, EFKA 3522, EFKA 3580, EFKA 3772, EFKA 4500, EFKA 4510, EFKA 4520, EFKA 4530, EFKA 4540, EFKA 4550, EFKA 4560, EFKA 4570, EFKA 6220, EFKA 6225, EFKA 6230 and EFKA 6525 from Ciba Specialty Chemicals of Tarrytown, N.Y.; SURFYNOL™ CT-111, SURFYNOL CT-121, SURFYNOL CT-131, SURFYNOL CT-211, SURFYNOL CT 231, SURFYNOL CT-136, SURFYNOL CT-151, SURFYNOL CT-171, SURFYNOL CT-234, CARBOWET™ DC-01, SURFYNOL 104, SURFYNOL PSA-336, SURFYNOL 420, SURFYNOL 440, ENVIROGEM™ AD-01 and ENVIROGEM AE01 from Air Products & Chemicals, Inc. of Allentown, Pa.; TAMOL™ 1124, TAMOL 850, TAMOL 681, TAMOL 731 and TAMOL SG-1 from Rohm and Haas Co. of Philadelphia, Pa.; IGEPAL™ CO-210, IGEPAL CO-430, IGEPAL CO-630, IGEPAL CO-730, and IGEPAL CO-890 from Rhodia Inc. of Cranbury, NJ.; T-DET™ and T-MULZ™ products from Harcros Chemicals Inc. of Kansas City, Kans.; polydimethylsiloxane surface-active agents (such as those available under the trade designations SILWET™ L-760 and SILWET L-7622 from OSI Specialties, South Charleston, W. Va., or BYK 306 from Byk Chemie) and fluorinated surface-active agents (such as that commercially available as FLUORAD FC-430 from 3M Co., St. Paul, Minn.). The surface-active agent may be a defoamer. Exemplary defoamers include BYK 018, BYK 019, BYK 020, BYK 022, BYK 025, BYK 032, BYK 033, BYK 034, BYK 038, BYK 040, BYK 051, BYK 060, BYK 070, BYK 077 and BYK 500 from Byk Chemie; SURFYNOL DF-695, SURFYNOL DF-75, SURFYNOL DF-62, SURFYNOL DF-40 and SURFYNOL DF-110D from Air Products & Chemicals, Inc.; DEEFO™ 3010A, DEEFO 2020E/50, DEEFO 215, DEEFO 806-102 and AGITAN™ 31BP from Munzing Chemie GmbH of Heilbronn, Germany; EFKA 2526, EFKA 2527 and EFKA 2550 from Ciba Specialty Chemicals; FOAMAX™ 8050, FOAMAX 1488, FOAMAX 7447, FOAMAX 800, FOAMAX 1495 and FOAMAX 810 from Degussa Corp.; FOAMASTER™ 714, FOAMASTER A410, FOAMASTER 111, FOAMASTER 333, FOAMASTER 306, FOAMASTER SA-3, FOAMASTER AP, DEHYDRAN™ 1620, DEHYDRAN 1923 and DEHYDRAN 671 from Cognis Corp.

Exemplary coating compositions may contain one or more optional pigments. Pigments suitable for use in the coating compositions will be known to persons having ordinary skill in the art or can be determined using standard methods. Exemplary pigments include titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, or organic yellows (such as Hansa yellow). The composition can also include a gloss control additive or an optical brightener, such as that commercially available under the trade designation UVITEX™ OB from Ciba-Geigy.

In certain embodiments it is advantageous to include fillers or inert ingredients in the coating composition. Fillers or inert ingredients extend, lower the cost of, alter the appearance of, or provide desirable characteristics to the composition before and after curing. Exemplary fillers or inert ingredients include, for example, clay, glass beads, calcium carbonate, talc, silicas, feldspar, mica, barytes, ceramic microspheres, calcium metasilicates, organic fillers, and the like. For example, the composition may include abrasion resistance promoting adjuvants such as silica or aluminum oxide (e.g., sol gel processed aluminum oxide). Suitable fillers or inert ingredients are preferably present in an amount of less than 15 weight %, based on the total coating composition weight.

The disclosed coating compositions may include wax emulsions to improve coating physical performance or rheology control agents to improve application properties. Exemplary wax emulsions include MICHEM™ Emulsions 32535, 21030, 61335, 80939M and 7173MOD from Michelman, Inc. of Cincinnati, Ohio and CHEMCOR™ 20N35, 43A40, 950C25 and 10N30 from ChemCor of Chester, N.Y. Exemplary rheology control agents include RHEOVIS™ 112, RHEOVIS 132, RHEOVIS152, VISCALEX™ HV30, VISCALEX AT88, EFKA 6220 and EFKA 6225 from Ciba Specialty Chemicals; BYK 420 and BYK 425 from Byk Chemie; RHEOLATE™ 205, RHEOLATE 420 and RHEOLATE 1 from Elementis Specialties of Hightstown, N.J.; ACRYSOL™ L TT-615, ACRYSOL RM-5, ACRYSOL RM-6, ACRYSOL RM-8W, ACRYSOL RM-2020 and ACRYSOL RM-825 from Rohm and Haas Co.; NATROSOL™ 250LR from Hercules Inc. of Wilmington, Del. and CELLOSIZE™ QP09L from Dow Chemical Co. of Midland, Mich.

The disclosed coating compositions may include a biocide, fungicide, mildewcide or other preservative. Exemplary such materials include KATHON™ LX microbicide, ROZONE™ 2000 fungicide and ROCIMA™ 80 algicide from Rohm & Haas of Philadelphia, Pa., the BUSAN™ series of bactericides, fungicides and preservatives including BUSAN 1292 and 1440 from Buckman Laboratories of Memphis, Tenn.; the POLYPHASE™ series of bactericides, fungicides and algaecides including POLYPHASE™ 663 and 678 from Troy Chemical Corp. of Florham Park, N.J., the IRGAROL™ and NUOSEPT™ series of biocides including NUOSEPT 91, 101, 145, 166, 495, 497, 498, 515, 635W and 695 from International Specialties Products, the FUNGITROL™ series of fungicides including FUNGITROL C, 334, 404D, 720, 920, 960, 2002, and 2010 from International Specialties Products, the DOWICIL™ series of antimicrobials and preservatives including DOWICIL 75, 96, 150, 200, and QC-20 from Dow Chemical Co., and the microbiostat preservative 1,2-benzisothiazolin-3-one (PROXEL® AQ from Arch Chemicals, Inc.).

The coating composition may also include other adjuvants which modify properties of the coating composition as it is stored, handled, or applied, and at other or subsequent stages. Desirable performance characteristics include chemical resistance, abrasion resistance, hardness, gloss, reflectivity, appearance, or combinations of these characteristics, and other similar characteristics. Many suitable adjuvants are described in Koleske et al., Paint and Coatings Industry, April, 2003, pages 12-86 or will be familiar to those skilled in the art. Representative adjuvants include amines, anti-cratering agents, colorants, curing indicators, dispersants, dyes, flatting agents (e.g., BYK CERAFLOUR™ 920 from Byk Chemie), glycols, heat stabilizers, leveling agents, mar and abrasion additives, optical brighteners, plasticizers, sedimentation inhibitors, thickeners, ultraviolet-light absorbers and the like to modify properties.

The disclosed coating compositions preferably have a minimum film forming temperature (MFFT) about 0 to about 55° C., more preferably about 0 to about 20° C., when tested with a Rhopoint 1212/42, MFFT Bar-60, available from Rhopoint Instruments Ltd. of East Sussex, United Kingdom. The coating compositions when dried or otherwise hardened may for example have an average total thickness between about 5 and about 200 micrometers, between about 10 and 150 micrometers, or between about 15 and 100 micrometers. The compositions preferably have a PVC (pigment volume concentration) of less than about 50 percent, more preferably less than about 35 percent, and most preferably less than about 25 percent, based upon the volume fraction of pigment in the polymer latex system. In certain aspects, the disclosed coating compositions preferably have a minimum film forming temperature (MFFT) about 0 to about 55° C., more preferably about 0 to about 20° C., when tested with a Rhopoint 1212/42, MFFT Bar-60, available from Rhopoint Instruments Ltd. of East Sussex, United Kingdom, wherein the compositions preferably include less than 10 weight %, more preferably less than 7 weight %, and most preferably less than 4 weight % total VOCs based upon the total composition weight.

The coating composition may be applied directly to the substrate or to an optionally sealed or primed substrate using any suitable application method. For example, the coating composition may be roll coated, sprayed, curtain coated, vacuum coated, brushed, or flood coated using an air knife system. For field applied coating systems, e.g., cement garage floors, floor tiles, decks, and the like, the coating desirably is applied, for example, by rolling, spraying, or brushing. For factory-applied applications, preferred application methods provide a uniform coating thickness and are cost efficient. Especially preferred application methods employ factory equipment which moves a substrate with a first major surface past a coating head and thence past suitable drying or curing equipment. The coating composition desirably covers at least a portion of the first major surface of the substrate, and preferably covers the entire first major surface, in a substantially uniformly thick layer. Accordingly, the disclosed coated articles preferably are coated on at least one major surface with the coating composition. More preferably, the coated articles are coated on a major surface and up to four minor surfaces including any edges. Most preferably, the coated articles are coated on all (e.g., both) major surfaces, and up to four minor surfaces including any edges.

In certain aspects, the coating composition or paints described herein have a scrub resistance of at least about 350 scrub cycles, at least about 400 scrub cycles, at least about 500 scrub cycles, at least about 600 scrub cycles, at least about 700 scrub cycles, at least about 750 scrub cycles, at least about 800 scrub cycles, at least about 900 scrub cycles, at least about 1000 scrub cycles, at least about 1100 scrub cycles, at least about 1200 scrub cycles, at least about 1300 scrub cycles, at least about 1400 scrub cycles, at least about 1500 scrub cycles, at least about 1600 scrub cycles, at least about 1700 scrub cycles, at least about 1750 scrub cycles, at least about 1800 scrub cycles, at least about 1850 scrub cycles. In certain aspects, the coating composition or paints have a scrub resistance up to about 1850 scrub cycles, up to about 1800 scrub cycles, up to about 1750 scrub cycles, up to about 1700 scrub cycles, up to about 1600 scrub cycles, up to about 1500 scrub cycles, up to about 1400 scrub cycles, up to about 1300 scrub cycles, up to about 1200 scrub cycles, up to about 1100 scrub cycles, or up to about 1000 scrub cycles. In certain aspects, the coating composition or paints have a scrub resistance between about 300 to about 1850 scrub cycles, between about 500 to about 1700 scrub cycles, between about 750 to about 1500 scrub cycles, or between about 1000 to about 1850 scrub cycles.

In certain aspects, the coating composition or paints described herein have a dirt pickup value (ΔE) of less than 8.5, preferably less than 8, preferably less than 7, preferably less than 6.5, preferably less than about 6. The dirt pickup values determined by applying a coating to a white mylar chart at a coating thickness of 10 mil (25.40 μm) using a Dow bar and allowed to cure for 24 hours, the coated panel being placed in a QUV and run a cycle according to ASTM G154 (8 hr UV-A/4 Hr. condensation), dirt then placed on the panel and put in an oven at 50° C. for one hour, and then the samples being removed from the oven with excess dirt being tapped from the panel. For each sample, ΔE values determined by the amount of residual dirt remaining on the sample.

The following examples are offered to aid in understanding of the present invention and are not to be construed as limiting the scope thereof. Unless otherwise indicated, all parts and percentages are by weight. The Tg inflection points can be determined using a Q SERIES™ DSC thermal analysis instrument from TA Instruments of New Castle, Del. For Tg values that were not capable of being measured, the Tg values were calculated using the Fox equation.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods. The following abbreviations may be used in the following examples: ppm=parts per million; mL=milliliter; L=liter; m=meter, mm=millimeter, cm=centimeter, kg=kilogram, g=gram, min=minute, s=second, hrs=hour, ° C.=degrees Celsius, ° F.=degrees Farenheit, MPa=megapascals, and N-m=Newton-meter, Mn=number average molecular weight, cP=centipoise.

Unless otherwise noted, the following exemplary multistage latex polymers were formed from materials provided in the Materials Table.

Materials Table

| Material | Function | Source |
|---|---|---|
| Deionized Water | Continuous Phase | Millipore-Sigma |
| Ammonium Persulfate | Initiator | United Initiators, Elyria, Ohio |
| Seed Latex | Seed Polymer | A styrene acrylate polymer with |
| | | a solids content of 30% and |
| | | particle size of 35 nm made by |
| | | emulsion polymerization with |
| | | an anionic surfactant |
| DISPONIL FES 993 | Emulsifier/Surfactant | BASF Corporation, Princeton, |
| | | NJ |
| Methacrylic Acid (Tg = 185° C.) | Monomer | Millipore-Sigma |
| Acrylic Acid (Tg = 106° C.) | Monomer | Millipore-Sigma |
| Methyl Methacrylate (Tg = 105° C.) | Monomer | Millipore-Sigma |
| n-Butyl Acrylate (Tg = 54° C.) | Monomer | BASF Corporation, Princeton, |
| | | NJ |
| n-Butyl Methacrylate (Tg = 20° C.) | Monomer | Sigma Aldrich |
| Diacetone Acrylamide (Tg = 64.9° C.) | Monomer | Sigma Aldrich |
| t-Butyl Hydroperoxide | Inititiator (oxidizer) | United Initiators, Elyria, OH |
| Isoascorbic Acid | Initiator (reducer) | Millipore-Sigma |
| Adipic Acid Dihydrazide | Crosslinking Promoter | Sigma Aldrich |
| Ammonia, 26 Degree Baume, 30% | Volatile Base | Viking Chemical Company, |
| active ammonia | | Rockford, IL |

### Test Methods

Unless indicated otherwise, the following test methods may be utilized.

### Example 1

### Multistage Latex Polymer

An exemplary multistage silane-functional latex polymer capable of keto-hydrazide crosslinking with a dihydrazide may be prepared as follows. A reactor is charged with 500-800 parts of deionized water and 2-6 parts emulsifier. The reaction mixture is heated to 75°−80° C. under a nitrogen blanket. During heating, pre-emulsion 1 is formed having 75-250 parts of deionized water, 2-9 parts of emulsifier (e.g., DISPONIL FES 993), 0.2-0.6 parts persulfate initiator (e.g., ammonium persulfate or sodium persulfate), 50-150 parts of n-butyl acrylate, 1-200 parts of methylmethacrylate, 250-450 parts of butyl methacrylate, 1-40 parts of DAAM, 1-15 parts vinyl trimethoxysilane, and 5-30 parts of (meth)acrylic acid. In a separate vessel, pre-emulsion 2 is formed having 75-250 parts of deionized water, 2-9 parts of emulsifier (e.g., DISPONIL FES 993), 0.2-0.6 parts persulfate initiator (e.g., ammonium persulfate or sodium persulfate), 150-500 parts of methylmethacrylate, 5-100 parts of n-butyl acrylate, 1-40 parts of DAAM, 1-15 parts vinyl trimethoxysilane, and 5-30 parts of acrylic acid. After the reaction mixture reaches 75° C., 1-6 parts of persulfate initiator is added to the reactor and the pre-emulsion 1 is added over a 1-3 hour feed rate. After pre-emulsion 1 is added, the container is rinsed with 20 parts deionized water and pre-emulsion 2 is added over a 1-3 hour feed rate. The reaction temperature is held between 80° C. and 85° C. during polymerization. After the pre-emulsion 2 feed is complete, the container is rinsed with 20 parts of deionized water and the reaction is held 30 minutes. Post-reaction addition of 0.5-1.5 parts t-butyl hydroperoxide mixed with 20 parts of deionized water and 0.3-1.5 parts of isoascorbic acid mixed with 20 parts of deionized water are then carried out over 30 minutes. Adipic acid dihydrazide in an amount of less than one mole per mole of DAAM is added to promote the keto-hydrazide crosslinking of the multistage latex polymer. The resulting crosslinked multistage latex polymer is then cooled to 40° C., and 28% ammonia is added to adjust the pH to 8.0-9.0. The resulting crosslinked multistage latex polymer is expected to have a soft stage having a Tg calculated by the Fox equation greater than −65° C. and less than 30° C., at least one hard stage having a Tg calculated by the Fox equation greater than 30° C. and less than 230° C.

### Example 2

### Silane-Functional Multistage Latex Polymer

To a 3-L reaction flask, 431 g of deionized water (DIW), and 155.4 g of a preformed polymeric seed emulsion were added. The seed emulsion was 30% solids and the particle size of the seed polymer was 35+/−5 nm. While stirring the contents of the reaction flask, the contents were heated to 176° F. (80° C.). Stirring the contents of the flask was maintained throughout the remainder of the procedure, which followed the method of Example 1 to form a multistage latex polymer prepared from a first monomer mixture containing n-butyl acrylate, methyl methacrylate, n-butyl methacrylate, DAAM, acrylic acid, methacrylic acid and vinyl trimethoxysilane; and a second monomer mixture containing n-butyl acrylate, methyl methacrylate, DAAM, acrylic acid and vinyl trimethoxysilane. Five parts DAAM were employed per 100 parts total monomer. The polymer is expected to exhibit two distinct Tg values, namely a soft stage Tg calculated using the Fox equation at about 4.6° C. and a hard stage Tg calculated using the Fox equation at about 87.5° C., with a theoretical overall Tg calculated using the Fox equation of about 23.4° C. Solids were 40% and the MMFT was less than about 16° C. Adipic acid dihydrazide in an amount having a mole ratio less than 1 with the moles of DAAM was used to promote the keto-hydrazide crosslinking reaction.

### Example 3

### Clear Wet-Look Coating Composition

Various samples of a clear wet-looking coating composition comprising a multistage latex polymer made from at least one monomer capable of a keto-hydrazide crosslinking were prepared from a first monomer mixture containing n-butyl acrylate, methyl methacrylate, n-butyl methacrylate, DAAM, acrylic acid and methacrylic acid, and a second monomer mixture containing n-butyl acrylate, methyl methacrylate, DAAM, acrylic acid and methacrylic acid.

An exemplary clear-coating composition may be prepared as follows. In a mixing vessel equipped with a high-speed mixer and mixing blade mixer are charged 10 to 50 parts water and 40 to 85 parts of a multistage latex polymer solution. If desired, 0 to 20 parts other non-pigment additives may be introduced. If desired (for example, to make a pigmented coating rather than a clearcoat), up to about 50 parts of pigments or flatting agents may be introduced.

Representative clear-coating compositions were prepared using a multistage latex polymer. Using the method of Example 1 using a seed polymer as discussed in Example 2, a multistage latex polymer was prepared from a first monomer mixture containing n-butyl acrylate, methyl methacrylate, n-butyl methacrylate, DAAM, acrylic acid, methacrylic acid and vinyl trimethoxysilane; and a second monomer mixture containing n-butyl acrylate, methyl methacrylate, DAAM, acrylic acid and vinyl trimethoxysilane. In Sample 1, the multistage resin comprised about 1.9 wt. % DAAM. In Sample 2, the multistage resin comprised about 5.0 wt. % DAAM. Adipic acid dihydrazide in an amount having a mole ratio less than 1 with the moles of DAAM was used to promote the keto-hydrazide crosslinking reaction. In a Comparative Example, the multistage resin comprised 5 wt. % AEEM instead of DAAM.

Each of clear-coating compositions of Samples 1 and 2 and the Comparative Example were then prepared by combining the ingredients shown below in Table 1 in order (parts provided by weight and gallons) in a mixing vessel equipped with a high-speed mixer and mixing blade. In each of Samples 1 and 2 and the Comparative Example, the compositions were mixed for about 15 minutes using moderate agitation to provide clear coating compositions containing about 40 wt. % solids, less than 5 g/liter VOC, a pH of about 8.0-9.0, and MFFT of about 16° C. The multistage latex polymer is anticipated to have two distinct Tg values, namely a soft stage Tg calculated using the Fox equation at about 4.6° C. and a hard stage Tg calculated using the Fox equation at about 87.5° C.

TABLE 1
Clear Wet-Look Coating Formulation

| Raw Material | Pounds | Gallons |
|---|---|---|
| Water | 183.3 | 22 |
| Multistage Resin | 645.3 | 73.75 |
| Surfynol PSA-336 | 3.0 | 0.34 |
| (Evonik Corp.) | | |
| BYK 024 (BYK) | 3.0 | 0.35 |
| Texanol (Eastman) | 15.0 | 1.89 |
| Ammonium Hydroxide(28%) | 3.0 | 0.40 |
| Proxel AQ (Lonza) | 5.0 | 0.56 |
| Ethylene Glycol | 9.3 | 1.00 |
| Totals | 866.9 | 100.29 |

Each of Samples 1 and 2 and the Comparative Example underwent a wet/dry adhesion and blushing test. The tests were performed by applying to two coatings having a natural spread rate using a foam brush to a carerra black glass panel, the two coatings being applied four hours apart. Four hours after the second coat, half of the glass panel was immersed in water for about 12-16 hours. After the immersion time, the glass panel was taken out of the water, quickly blotted dry with a paper towel, and a crosshatch adhesion test according to ASTM D3359 was performed on the area of the glass panel that was immersed in water (for wet adhesion) and the area of the glass panel that was not immersed in water (for dry adhesion). To evaluate blushing, the dried immersed coating portion was evaluated for any opaqueness using a 1-5 ranking scale, with 5 corresponding to no opaqueness, and 1 corresponding to extreme opaqueness.

Each of Samples 1 and 2 and the Comparative Example also underwent abrasion testing. The tests were performed by applying a wet coating to a black mylar panel at an average wet coating thickness of 10 mil (25.40 μm) using a Dow bar and allowed to cure for 1 week at ambient temperature to achieve an average dry coating thickness of about 2.6 mil (6.60 μm). The coated panel was placed in a scrub machine (Gardco Model D10) and washed with a sponge containing an abrasive soap solution (8 mL of SC-2 Leneta-ASTM Scrub Media and 10 mL of water) for 500 scrub cycles. No shims were used. The panel was rinsed with water and dried overnight, and the weight of the panel before scrubbing and after scrubbing was recorded to determine the coating weight loss.

Each of Samples 1 and 2 and the Comparative Example also underwent dirt pickup testing. The testing was performed by applying a coating to a white mylar chart at an average wet coating thickness of 10 mil (25.40 μm) using a Dow bar and allowed to cure for 24 hours to achieve an average dry coating thickness of about 2.6 mil (6.60 μm). The coated panel was placed in a QUV and run a cycle according to ASTM G154 (8 hr UV-A/4 Hr. condensation). Dirt was then placed on the panel and put in an oven at 50° C. for one hour. Samples were taken out of the oven and excess dirt was tapped from the panel. For each sample, Delta E values were taken to determine the amount of residual dirt remaining on the sample.

The wet/dry adhesion, blushing, abrasion and dirt pickup testing results for Samples 1 and 2 and the Comparative Example are provided in Table 2.

TABLE 2
Clear Wet-Look Coating Composition Data

| | DAAM | Wet/Dry | | Weight | Dirt Pick- |
|---|---|---|---|---|---|
| | Level | Adhesion | Blushing | Loss (g) | up (ΔE)* |
| Sample 1 | 1.9 wt. % | 5B/5B | 5 | 0.11 | — |
| Sample 2 | 5 wt. % | 5B/5B | 5 | 0.02 | 6.1 |
| Comp. | 0 wt. % (5% | 5B/5B | 5 | 0.14 | 8.9 |
| Example | AAEM) | | | | |

As shown in Table 2, Sample 2 containing 5 wt. % DAAM had significantly improved abrasion/scrub resistance compared to the Comparative Sample containing 5 wt. % AEEM, yet retained good adhesion and blush resistance performance. Sample 2 containing DAAM in the multistage polymer also had better dirt pick-up performance than the Comparative Example containing AAEM.

### Example 4

### Pigmented Garage Floor Paint Compositions

An exemplary pigmented coating composition may be prepared as follows. In a mixing vessel equipped with a high-speed mixer and mixing blade mixer are charged 10 to 50 parts water and 40 to 85 parts of a multistage latex polymer solution. If desired, 0 to 20 parts other non-pigment additives may be introduced. If desired (for example, to make a pigmented coating rather than a clearcoat), up to about 50 parts of pigments or flatting agents may be introduced.

Representative pigmented coating compositions were prepared using a multistage latex polymer having at least one monomer capable of a keto-hydrazide crosslinking. Using the method of Example 1 and the a seed polymer as discussed in Example 2, a multistage latex polymer was prepared from a first monomer mixture containing n-butyl acrylate, methyl methacrylate, n-butyl methacrylate, DAAM, acrylic acid and methacrylic acid, and a second monomer mixture containing n-butyl acrylate, methyl methacrylate, DAAM, acrylic acid and methacrylic acid. In Sample 1, the multistage resin comprised about 1.9 wt. % DAAM. In Sample 2, the multistage resin comprised about 5.0 wt. % DAAM. In a Comparative Example, the multistage resin comprised 5 wt. % AEEM instead of DAAM.

Each of the pigmented coatings containing DAAM in the multistage polymer were then prepared by combining the ingredients shown below in Table 3 in order (parts provided by weight and gallons) in a mixing vessel equipped with a high-speed mixer and mixing blade. The compositions were mixed for about 15 minutes using moderate agitation to provide clear coating compositions containing to provide the pigmented coating compositions containing about 40 wt. % solids, less than 5 g/liter VOC, a pH of about 8.0-9.0, and MFFT of about 16° C. The multistage latex polymer is anticipated to have two distinct Tg values, namely a soft stage Tg calculated using the Fox equation at about 4.6° C. and a hard stage Tg calculated using the Fox equation at about 87.5° C., with a theoretical overall Tg calculated using the Fox equation being about 23.4° C. Adipic acid dihydrazide in an amount having a mole ratio less than 1 with the moles of DAAM was used to promote the keto-hydrazide crosslinking reaction.

TABLE 3
Grey Garage Floor Paint Formulation

| Raw Material | Pounds | Gallons |
|---|---|---|
| Water | 82.0 | 9.84 |
| Tamol 731 (Dow) | 7.0 | 0.76 |
| Triton CF-10 (Dow) | 3.0 | 0.34 |
| Drewplus L-475 (Ashland) | 1.0 | 0.13 |
| R902 (Chemours) | 75.0 | 2.19 |
| Minex 7 (Unimin) | 150.0 | 6.90 |
| Attagel 40 (BASF) | 2.0 | 0.10 |
| Potassium Tripolyphsophate | 1.5 | 0.07 |
| Resin | 552.5 | 63.14 |
| Proxel AQ (Lonza) | 5.0 | 0.55 |
| Ammonium Hydroxide 28% | 1.0 | 0.13 |
| Ethylene Glycol | 9.33 | 1.00 |
| Water | 80.8 | 9.70 |
| EPS 9147 Coalescent (EPS) | 22.0 | 2.51 |
| Drewplus L475 (Ashland) | 2.0 | 0.26 |
| Acrysol RM-825 (Dow) | 1.0 | 0.11 |
| Acrysol RM-2020 (Dow) | 6.0 | 0.66 |
| Carbon Black Colorant (EPS) | 7.84 | 0.77 |
| Yellow Oxide Colorant (EPS) | 5.22 | 0.33 |
| Totals | 1014.19 | 99.49 |

Each of Samples 1 and 2 and the Comparative Example underwent scrubability testing. Scrub resistance was tested using the MPI #60 Test Standard (Standard Test Method—Floor Paint, Latex, Low Gloss), with the exception that Leneta SC-2 abrasive scrub media was used and Section 7.5 of MPI #60 applied as relating to Test Method B of ASTM Method D2486. The paint formulations were applied to a black mylar substrate having an average wet coating thickness of 7 mil (17.78 μm) using a Dow bar and allowed to cure for 1 week at ambient temperature to achieve an average dry coating thickness of about 2.6 mil (6.60 μm). The wet coating being applied with an appropriate amount of thickener and coalescence such that the cured coating did not contain any visual cracking to the unaided eye of an ordinary observer. The scrubability test results are shown in Table 4.

TABLE 4
Scrubability Testing Data for Pigmented Coatings

| | DAAM (wt. %) | Scrubs |
|---|---|---|
| Sample 1 | 1.9 | 750 |
| Sample 1 | 5 | 1850 |
| Comparative | 0 (5 wt. % | 300 |
| Example | AAEM) | |

As shown in Table 4, Samples 1 and 2 containing 1.9 and 5 wt. % DAAM, respectively, had significantly improved scrubability compared to the Comparative Example containing 5 wt. % AEEM. The data also illustrates that the scrubability performance significantly increases with the amount of DAAM present in the multistage polymer.

Other embodiments of the invention include without limitation those listed below:

A method for preparing a coated article, which method comprises providing a cementitious substrate, coating at least a portion of the substrate with an aqueous coating composition comprising a silane-functional multistage latex polymer having keto-hydrazide crosslinking, and allowing the coating composition to harden.

The foregoing method, wherein the multistage latex polymer is formed by chain-growth polymerization in the presence of a silane coupling agent containing a functional group capable of copolymerizing with a monomer from which the multistage latex polymer is formed.

Any of the foregoing methods, wherein the silane coupling agent contains an ethylenically unsaturated group.

Any of the foregoing methods, wherein the silane coupling agent comprises a vinyl silane.

Any of the foregoing methods, wherein the silane-functional multistage polymer contains about 0.2 to about 10 weight % silane, based on a comparison of silane coupling agent weight to latex polymer weight.

Any of the foregoing methods, wherein the silane-functional multistage polymer contains about 0.5 to about 6 weight % silane, based on a comparison of silane coupling agent weight to latex polymer weight.

Any of the foregoing methods, wherein the multistage latex polymer is made silane-functional by reacting an already-formed multistage latex polymer with a silane coupling agent having a functional group which reacts with the already-formed polymer.

Any of the foregoing methods, wherein the silane coupling agent comprises an epoxy silane or amino silane.

Any of the foregoing methods, wherein the multistage latex polymer comprises at least one soft stage having a Tg between about −65 and about 30° C. and at least one hard stage having a Tg between about 30 and about 230° C.

Any of the foregoing methods, wherein the multistage latex polymer comprises 50 to 90 weight % soft stage polymer morphology having a Tg between about −5 and 25° C. and 10 to 50 weight % hard stage polymer morphology having a Tg between about 30 and 105° C., based on total polymer weight.

Any of the foregoing methods, wherein the multistage latex polymer has a gradient Tg.

Any of the foregoing methods, wherein the multistage latex polymer has at least one monomer having an amide group.

A coated article comprising a cementitious substrate having at least one major surface on which is coated a layer comprising an aqueous coating composition comprising a silane-functional multistage latex polymer having keto-hydrazide crosslinking.

The foregoing article, wherein the substrate comprises fiber cement.

Any of the foregoing articles, wherein the substrate comprises fencing, roofing, flooring, decking, wall boards, shower boards, lap siding, vertical siding, soffit panels, trim boards, shaped edge shingle replicas, stone replicas or stucco replicas.

Any of the foregoing articles, wherein the coating composition has a pigment volume concentration less than 45%.

Any of the foregoing articles, wherein the coating composition has a minimum film forming temperature less than about 20° C.

Any of the foregoing articles, wherein the coating composition when dried or otherwise hardened has a total thickness between about 10 and about 150 micrometers.

Any of the foregoing articles, wherein the multistage latex polymer is formed by chain-growth polymerization in the presence of a silane coupling agent containing a functional group capable of copolymerizing with a monomer from which the multistage latex polymer is formed.

Any of the foregoing articles, wherein the silane coupling agent contains an ethylenically unsaturated group.

Any of the foregoing articles, wherein the silane coupling agent comprises a vinyl silane.

Any of the foregoing articles, wherein the silane-functional multistage polymer contains about 0.2 to about 10 weight % silane, based on a comparison of silane coupling agent weight to latex polymer weight.

Any of the foregoing articles, wherein the coating or dried paint film contains a silicon-containing compound such as silane, in an amount of at least about 0.2 weight %, at least about 0.5 weight %, or at least about 0.7 weight % silane, based on a comparison of the weight of the silicon-containing starting material to the latex polymer weight.

Any of the foregoing articles, wherein the multistage latex polymer comprises at least one soft stage having a Tg between about −65 and about 30° C. and at least one hard stage having a Tg between about 30 and about 230° C.

Any of the foregoing articles, wherein the multistage latex polymer comprises 50 to 90 weight % soft stage polymer morphology having a Tg between about −5 and 25° C. and 10 to 50 weight % hard stage polymer morphology having a Tg between about 30 and 105° C., based on total polymer weight.

Any of the foregoing articles, wherein the multistage latex polymer has a gradient Tg.

Any of the foregoing articles, wherein at least one of the monomers of the multistage latex polymer has an amide functional group.

Any of the foregoing articles, wherein multistage latex polymer has a first stage and a second stage having different Tg values, wherein the difference in Tg (ΔTg) is at least about 35° C., preferably at least about 60° C., more preferably at least about 65° C.

Any of the foregoing articles, wherein multistage latex polymer has a first stage and a second stage having different Tg values, wherein the difference in Tg (ΔTg) is less than about 200° C., in some aspects less than about 150° C., and in some other aspects less than about 100° C.

Any of the foregoing articles, wherein multistage latex polymer has a first stage and a second stage having different Tg values, wherein the difference in Tg (ΔTg) is between about 35° C. and about 200° C., preferably at least about 60° C. to about 200° C., more preferably at least about 65° C. to about 200° C.

Any of the foregoing articles, wherein multistage latex polymer is intended for use in a pigmented high gloss or semi-gloss paint, the multistage latex polymer having a first stage and a second stage having different Tg values, the difference in Tg (ΔTg) is at least about 35° C., preferably at least about 60° C., more preferably at least about 65° C., and less than about 200° C., in some aspects less than about 150° C., and in some other aspects less than about 100° C.

Any foregoing articles, wherein multistage latex polymer is derived from monomers that include methyl methacrylate (Tg=100° C.), methacrylic acid (Tg=185° C.), diacetone acrylamide (Tg=64.9° C.), n-butyl acrylate (Tg=54° C.), and n-butyl methacrylate (Tg=20° C.).

Any foregoing articles, wherein multistage latex polymer is derived from a first monomer mixture containing n-butyl acrylate, methyl methacrylate, n-butyl methacrylate, DAAM, acrylic acid, methacrylic acid and vinyl trimethoxysilane, and a second monomer mixture containing n-butyl acrylate, methyl methacrylate, DAAM, acrylic acid and vinyl trimethoxysilane, and wherein adipic acid dihydrazide in an amount having a mole ratio less than 1 with the moles of DAAM being used to promote the keto-hydrazide crosslinking reaction.

All patents, patent applications and literature cited in the specification are hereby incorporated by reference in their entirety. In the case of any inconsistencies, the present disclosure, including any definitions therein will prevail. The invention has been described with reference to various specific and preferred embodiments and techniques. However, it should be understood that many variations and modifications may be made while remaining within the invention.

Having thus described the preferred embodiments of the present invention, those of skill in the art will readily appreciate that the teachings found herein may be applied to yet other embodiments within the scope of the attached claims.

1-58. (canceled)

59. A coating composition, comprising:
water;
a multistage latex polymer prepared from components comprising diacetone acrylamide (DAAM); and
at least one hydrazide selected from a dihydrazide, a trihydrazide, a polyhydrazide, and mixtures thereof;
wherein the multistage latex polymer has a first stage and a second stage having different Tg values, wherein the difference in Tg (ΔTg) is at least about 35° C.

60. The coating composition of claim 59 wherein the at least one hydrazide comprises a carbohydrazide.

61. The coating composition of claim 60 wherein the at least one hydrazide comprises adipic acid dihydrazide.

62. The coating composition of claim 59 wherein the multistage latex polymer is prepared from components comprising DAAM and two or more ethylenically unsaturated monomers selected from acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate, acrylamide, methacrylamide, methylol (meth)acrylamide, stryrene, alpha-methyl styrene, vinyl toluene, vinyl acetate, vinyl propionate, allyl methacrylate, and mixtures thereof.

63. The coating composition of claim 59 wherein the multistage latex polymer is prepared from components comprising DAAM and two or more ethylenically unsaturated monomers comprising methyl methacrylate, methacrylic acid, n-butyl acrylate, n-butyl methacrylate, 2-ethyl hexyl acrylate, or mixtures thereof.

64. The coating composition of claim 63 wherein the two or more ethylenically unsaturated monomers comprise methyl methacrylate and one or more of n-butyl acrylate and n-butyl methacrylate.

65. The coating composition of claim 63 wherein the two or more ethylenically unsaturated monomers comprise methyl methacrylate and 2-ethylhexyl acrylate.

66. The coating composition of claim 59 wherein the difference in Tg (ΔTg) is at least about 65° C.

67. The coating composition of claim 59 wherein the difference in Tg (ΔTg) is less than about 100° C.

68. The coating composition of claim 62 wherein the multistage latex polymer comprises at least one soft stage having a Tg calculated by the Fox equation greater than −65° C. and less than 30° C., at least one hard stage having a Tg calculated by the Fox equation greater than 30° C. and less than 230° C.

69. The coating composition of claim 59 wherein the multistage latex polymer has a gradient Tg.

70. The coating composition of claim 59 wherein the multistage latex polymer is derived from about 0.5 weight % to about 7.5 weight % of diacetone acryamide, based on the total weight of monomers used to form the latex polymer.

71. The coating composition of claim 59 further comprising a silicon-containing compound.

72. The coating composition of claim 59 wherein the multistage latex polymer includes silane functionality.

73. The coating composition of claim 72 wherein the silane-functional multistage latex polymer is formed using a silane coupling agent or a silane-functional additive.

74. The coating composition of claim 73 wherein the multistage latex polymer comprises at least about 0.25 weight % and less than about 10 weight %, based on the total weight of the multistage latex polymer, of a silane coupling agent that improves adhesion of the coating composition to a cementitious substrate or a wood substrate.

75. The coating composition of claim 59 further comprising one or more nonionic, anionic, or cationic surfactants.

76. A coating composition, comprising:
water;
a multistage latex polymer prepared from components comprising two or more ethylenically unsaturated monomers, at least one of which is diacetone acrylamide (DAAM); and
at least one hydrazide selected from a dihydrazide, a trihydrazide, a polyhydrazide, and mixtures thereof;
wherein the multistage latex polymer has a first stage and a second stage having different Tg values, wherein the difference in Tg (ΔTg) is at least about 35° C.; and
wherein the coating composition comprises at least 10 weight % of the multistage latex polymer, based on total composition solids.

77. The coating composition of claim 76 comprising less than 10 weight % volatile organic compounds (VOCs), based on the total weight of the coating composition.

78. The coating composition of claim 76 wherein a total solids of the coating composition is at least 20 weight % and less than 55 weight %.

79. The coating composition of claim 78 wherein the coating composition is a clear sealer without any pigment.

80. The coating composition of claim 78 wherein the coating composition has a pigment, and wherein a total solids of the coating composition is at least 25 weight % and less than 55 weight %.

81. The coating composition of claim 75 wherein the difference in Tg (ΔTg) is at least about 65° C. and less than about 100° C.

82. A coating composition, comprising:
water;
a multistage latex polymer prepared from components comprising:
two or more ethylenically unsaturated monomers selected from methyl methacrylate, methacrylic acid, n-butyl acrylate, n-butyl methacrylate, 2-ethyl hexyl acrylate, and mixtures thereof; and
about 0.5 weight % to about 7.5 weight % of diacetone acryamide (DAAM), based on the total weight of monomers used to form the latex polymer; and
adipic acid dihydrazide;
wherein the multistage latex polymer has a first stage and a second stage having different Tg values, wherein the difference in Tg (ΔTg) is at least about 35° C.; and
wherein the coating composition comprises at least 35 weight % of the multistage latex polymer, based on total composition solids.

83. The coating composition of claim 82 wherein a mole ratio of diacetone acrylamide relative to the adipic acid dihydrazide is between 1:0.33 and 1:1.36.

84. The coating composition of claim 82 wherein a coating, having an average dry coating thickness of 2.6 mil (6.60 μm), formed from the coating composition applied to a black mylar substrate and allowed to cure for 1 week at ambient temperature, has a scrub resistance of at least about 750 scrubs.

85. A method for preparing a coated article, the method comprising:
providing a cementitious substrate;
coating or causing to be coated at least a portion of the substrate with the coating composition of claim 59; and
allowing the coating composition to harden.

86. The method of claim 85 wherein the cementitious substrate comprises a concrete garage floor.

87. The method of claim 85 wherein a coating formed from the coating composition has a dirt pickup (AE) value less than about 8.

88. A coated article comprising a cementitious substrate having a coating disposed on at least a portion of a surface, wherein the coating comprises a layer formed from the coating composition of claim 59.
